(19) United States
(12) Patent Application Publication
(10) Pub. No.: US 2026/0107152 A1
(43) Pub. Date: Apr. 16, 2026

(54) EXTENDED CAPACITY PLANNING GRAPHICAL USER INTERFACE FOR CELLULAR NETWORK

(71) Applicant: DISH Wireless L.L.C., Englewood, CO (US)

(72) Inventors: Ahmed Awwad Whdan, Centennial, CO (US); Satish Kumar Sharma, Englewood, CO (US)

(21) Appl. No.: 18/911,607

(22) Filed: Oct. 10, 2024

(51) Int. Cl. H04W 16/18; H04W 4/021; H04W 16/22

(52) U.S. Cl. CPC H04W 16/18; H04W 4/021; H04W 16/22

(57) ABSTRACT

A method includes presenting, within a display device of a computing system, a graphical user interface (GUI) with a map and an input selector window having component types of the cellular network associated with sites. In response to detecting, through the input selector window, selection of component type(s), the method includes retrieving geolocation data for a plurality of components corresponding to the one or more component types and presenting, within the GUI over the map, graphical objects representing the plurality of components consistent with the geolocation data. The method includes retrieving, from memory, capacity data associated with the plurality of components and shading, based on the capacity data, each graphical object to indicate a capacity status associated with each corresponding component of the plurality of components.

### BACKGROUND

Telecommunication networks, such as cellular networks, have various resources that produce data and metadata concerning operations of the cellular network. Metadata is data that provides information about data. Metadata enriches the data with information about one or more aspects of the data. Metadata insights can facilitate efficient processing and understanding the data. Status reports, including error codes, may be generated which are indicative of deficiencies in operations of the network, including deficiencies in network capacity and connectivity.

With the development of communication technologies, such as fifth generation (5G) new radio (NR) cellular networks, applications supporting a massive number of connected devices are enabled. Such applications can be based on data from myriad sources, including third party sources. Also, as the number of connected devices grows, ensuring that network capacity commensurately grows can be challenging, particularly in meeting increasing cellular traffic demands for that network capacity. Typically, engineers manually analyze alerts, errors, broken connections, and other capacity deficiencies to determine where design changes are necessary in the cellular network. This means that design changes to address capacity deficiencies are generally insufficient, overly costly, and/or untimely.

### BRIEF DESCRIPTION OF DRAWINGS

The present disclosure is illustrated by way of example, and not by way of limitation, in the figures of the accompanying drawings.

FIG. 1A is a block diagram of a cellular network system including a computing system in or associated with the cellular network for purposes of capacity planning according to at least one embodiment.

FIG. 1B is a block diagram of the computing system of FIG. 1A according to some embodiments.

FIG. 2A, FIG. 2B, FIG. 2C, FIG. 2D illustrate a graphical user interface (GUI), including a map of an area of interest (AOI) of the cellular network, presentable on a display device of the computing system according to at least some embodiments.

FIG. 3 is an image of a menu presentable within the GUI as an overlay to the map and that provides selection options of various capacity-related aspects of the cellular network according to some embodiments.

FIG. 4 is a screen capture of the GUI after selection of a site ranking option within the menu of FIG. 3 according to at least one embodiment.

FIG. 5A and FIG. 5B are images each illustrating a build score card that can be presented within a pop-up window to illustrate the detail of one of the site rankings illustrated in FIG. 4 according to two embodiments.

FIG. 6 is an image of a metric overlay of capacity metrics presented within a pop-up window in response to selection of a cell indicator of a cell of a site according to at least one embodiment.

FIG. 7 is an image of a metric overlay of capacity metrics presented within a pop-up window in response to selection of a sector-level indicator of a site according to an embodiment.

FIG. 8 is a screen capture of the GUI including a date selector presented as an overlay within a selection window according to some embodiments.

FIG. 9 is a flow chart of a method of illustrating components of a cellular network and predicting capacity metrics of those components at a future time according to at least one embodiment.

FIG. 10A is a screen image of the GUI after selection, within an input selector window, of various components of the cellular network according to some embodiments.

FIG. 10B is an image of an exemplary input selector window within the GUI from which to select the various components according to some embodiments.

FIG. 11 is an image of a metric overlay of capacity metrics within a pop-up window in response to selection of a distributed unit (DU) component of the cellular network according to at least one embodiment.

FIG. 12 is an image of a metric overlay of capacity metrics within a pop-up window in response to selection of a centralized unit (CU) component of the cellular network according to at least one embodiment.

FIG. 13 is an image of a metric overlay of capacity metrics within a pop-up window in response to selection of a front-haul segment component of the cellular network according to at least one embodiment.

FIG. 14 is an image of a metric overlay of capacity metrics within a pop-up window in response to selection of a mid-haul segment component of the cellular network according to at least one embodiment.

FIG. 15 is a screen capture of the GUI, which presents the components as graphical objects and a date selector as an overlay within a selection window according to some embodiments.

FIG. 16 is a flow chart of a method of illustrating components of a cellular network and illustrating graphical objects in a way that is representative of capacity status according to at least one embodiment.

FIG. 17 is an operational flow diagram associated with a solutions dropdown menu, upon selecting a component of a site, to make design changes to the component according to some embodiments.

FIG. 18 is a set of images of graphical objects within the GUI representing neighboring sites and operational flow of shifting traffic between sectors of the neighboring sites according to some embodiments.

FIG. 19 is an image of a graphical object representing a site and illustrating optional addition of a new source of capacity to the sector according to some embodiments.

FIG. 20 is a flow chart of a method of offering solutions, through the GUI, via particular design changes to a component of a site according to some embodiments.

FIG. 21 illustrates a block diagram illustrating an exemplary computer device (or computing device), in accordance with implementations of the present disclosure.

### DETAILED DESCRIPTION

As discussed above, as communication technologies advance, including the emergence of 5G new radio cellular networks, as the number of connected devices grows, ensuring that cellular network capacity commensurately grows can be challenging, particularly in meeting increasing cellular traffic demands for that network capacity. Typically, engineers manually analyze alerts, errors, broken connections, and other capacity deficiencies to determine where design changes are necessary. This can mean that design changes to address capacity deficiencies are generally insufficient, overly costly, and/or untimely. Also, without the ability to visually see interactions of sites within the cellular network, design changes are made more complicated and less intuitive.

Aspects and embodiments of the present disclosure overcome these deficiencies and others by implementing a compute-driven capacity planning tool that presents, within a display device, based on geolocation data, a graphical user interface (GUI) having a map with graphical objects representing components (or elements) of cellular sites of a cellular network throughout a selectable area of interest (AOI). A computing system implementing such a capacity planning tool can further make capacity data available via the GUI associated with respective components, e.g., upon detecting selection of an indicator of a graphical object. For example, the indicator and/or graphical object can represent a cell, a sector, a centralized unit (CU), a distributed unit (DU), a front-haul (FH) segment, a mid-haul (MH) segment, or the like site component of the cellular network. In various embodiments, the computing system is integrated, or in communication, with the cellular network, and thus able to retrieve and store data and metadata associated with capacity and connectivity of these various components.

Further, the computing system can retrieve and analyze capacity data associated with the components, determine which components have a capacity-related issue, and shade one or more indicators of the graphical objects to indicate a level of capacity deficiency. Upon selection of a shaded indicator or graphical object, the computing system can present, in the GUI, a metric overlay listing capacity metrics for the corresponding component and values for the capacity metrics, at least one of which satisfies (or nearly satisfies) a predetermined capacity threshold. In embodiments, the predetermined capacity threshold is associated with a significant capacity deficiency or inability to stay connected to the cellular network, such that corrective action is (or soon will be) necessary. Each capacity threshold can be programmable for different capacity metrics and adjusted over time. In this way, engineers and other operators can quickly detect where within the AOI of the cellular network particular levels of capacity-related issues exist and seek to address those issues.

Further, according to some embodiments, the computing system can detect selection of a future date through a date selector window at which time an operator desires to know predicted capacity issues associated with the components of the cellular network. In such embodiments, the computing system analyzes the capacity data to predict a plurality of capacity metrics at the future date for the plurality of sites. In embodiments, these capacity metrics can also be associated with, through the GUI, graphical objects representing components of each site. The computing system can further change shading of at least one indicator, corresponding to a cell of the plurality of cells, indicating that at least one capacity metric of the plurality of capacity metrics for the cell satisfies a predetermined capacity threshold for that capacity metric. The shading can be a color, a greyscale level, or a particular pattern or cross-hatching that is easily identifiable within the map.

In some embodiments, the computing system can further, in response to detecting selection of a graphical object associated with a component of the plurality of components (e.g., perhaps a left click selection), present a solutions dropdown menu listing design changes available to the component. The computing system can then, in response to detecting selection of a particular design change through the solutions dropdown menu, retrieve capacity data associated with the component, receive an input value associated with the particular design change (e.g., through a text box), and determine, based on the capacity data and the input value, updated values of a plurality of capacity metrics for at least the component of the plurality of components. In some embodiments, the computing system further determines the plurality of capacity metrics for at least some of the plurality of components that are impacted by the input value and presents, within the GUI, the updated values and the plurality of capacity metrics associated with the at least some of the plurality of components. In this way, capacity solutions can be simulated through the capacity planning tool of the computing system based on proposed design value changes, illustrating affects on capacity metrics of cellular components that are impacted by the proposed design changes.

Particular implementations of the subject matter described in this disclosure can be implemented so as to realize one or more of the following advantages. For example, the disclosed compute-driven capacity planning tool facilities capacity planning at different levels and in different AOIs of a cellular network, avoidance of losing connectivity between sites and components of sites within the cellular network, thus ensuring continued quality of service to users. Additional advantages involve the prediction into the future of possible capacity issues that can be addressed with planned design changes, simulation of those planned design changes to test their sufficiency, and projection of costs for such design changes. For example, particular design changes can be prioritized and budgets estimated so that an on-going expenditure for meeting capacity demands can be managed. In quickly growing cellular network environment, these advantages enable network engineers to efficiently keep pace to strategically grow impacted sites and areas of an AOI, project costs, and prevent over spending during such growth.

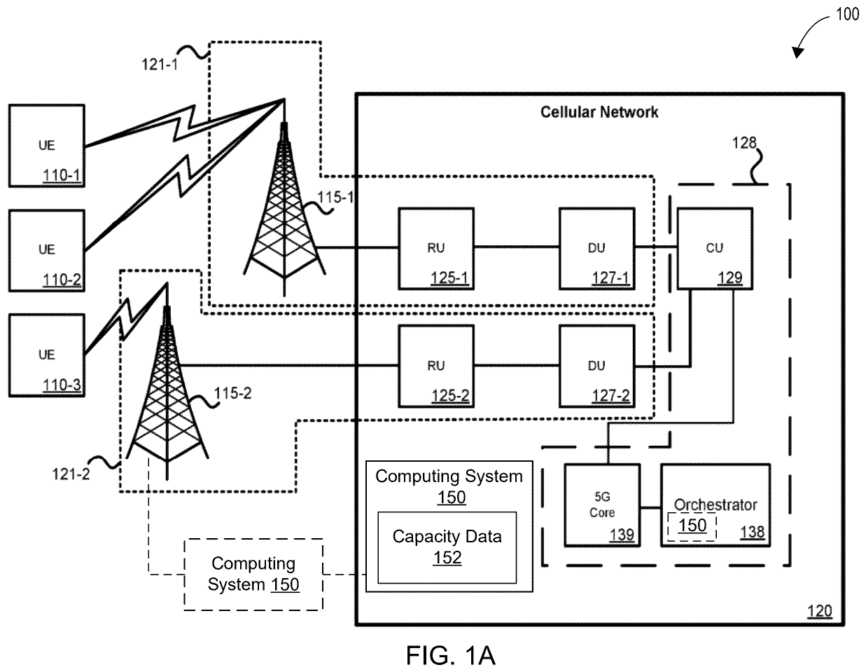

FIG. 1A is a block diagram of a cellular network system 100 including a computing system 150 in or associated with the cellular network for purposes of capacity planning according to at least one embodiment. FIG. 1A represents an embodiment of a cellular network which can accommodate the cloud-based architecture. System 100 can include a 5G New Radio (NR) cellular network; other types of cellular networks, such as 6G, 7G, etc. may also be possible. System 100 can include: UEs 110 (UE 110-1, UE 110-2, UE 110-3); base station structure 115; cellular network 120; radio units 125 (“RUs 125”); distributed units 127 (“DUs 127”); centralized unit 129 (“CU 129”); 5G core 139, and orchestrator 138. FIG. 1A represents a component-level view. In an open radio access network (O-RAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider, to accommodate where the functionality of such components is needed.

UE 110 can represent various types of end-user devices, such as cellular phones, smartphones, cellular modems, cellular-enabled computerized devices, sensor devices, gaming devices, access points (APs), and other computerized devices capable of communicating via a cellular network, etc. Generally, UE 110 can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. Depending on the location of individual UEs, UE 110 may use RF to communicate with various base stations of cellular network 120. As illustrated, two base stations are illustrated: base station 121-1 can include: structure 115-1, RU 125-1, and DU 127-1. Structure 115-1 may be any structure to which one or more antennas (not illustrated) of the base station are mounted. Structure 115-1 may be a dedicated cellular tower, a building, a water tower, or any other human-made or natural structure to which one or more antennas can reasonably be mounted to provide cellular coverage to a geographic area. Similarly, base station 121-2 can include: structure 115-2, RU 125-2, and DU 127-2.

Real-world implementations of system 100 can include many (e.g., thousands) of base stations and many CUs and 5G core 139. Each structure 115 can include one or more antennas that allow RUs 125 to communicate wirelessly with UEs 110. RUs 125 can each represent an edge of cellular network 120 where data is transitioned to wireless communication. The radio access technology (RAT) used by RU 125 may be 5G New Radio (NR), or some other RAT. The remainder of cellular network 120 may be based on an exclusive 5G architecture, a hybrid 4G/5G architecture, a 4G architecture, or some other cellular network architecture. Base station equipment 121 may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1 and DU 127-2, may communicate with CU 129. Collectively, an RU, DU, and CU create a gNodeB, which serves as the radio access network (RAN) of cellular network 120. CU 129 can communicate with the 5G core 139. The specific architecture of the cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1A illustrates various components of cellular network 120, other embodiments of cellular network 120 can vary the arrangement, communication paths, and specific components of cellular network 120, which will be expanded on in subsequent Figures. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible virtualized O-RAN implementation, CU 129, 5G core 139, and/or orchestrator 138 can be implemented virtually as software being executed by general-purpose computing equipment, such as in a data center of a cloud-computing platform, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components 128 include CU 129, 5G core 139, and orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

Kubernetes, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new core function, orchestrator 138 can perform a pipeline of calling the core function code from a software repository incorporated as part of, or separate from, cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QoS) and quality of experience (QoE) for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so it may be desired to avoid allocation of an excess of resources to a particular UE group and/or application. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing can be performed.

The 5G core 139, which can be physically distributed across data centers or located at a central national data center (NDC), can perform various core functions of the cellular network. The 5G core 139 can include: network resource management components; policy management components; subscriber management components; and packet control components. Individual components may communicate on a bus, thus allowing various components of 5G core 139 to communicate with each other directly. The 5G core 139 is simplified to show some key components. Implementations can involve additional other components.

Network resource management components can include network repository function (NRF) and network slice selection function (NSSF). NRF can allow 5G network functions (NFs) to register and discover each other via a standards-based application programming interface (API). NSSF can be used by access and mobility management function (AMF) to assist with the selection of a network slice that will serve a particular UE.

Policy management components can include charging function (CHF) and policy control function (PCF). CHF allows charging services to be offered to authorized network functions. Converged online and offline charging can be supported. PCF allows for policy control functions and the related 5G signaling interfaces to be supported.

Subscriber management components can include unified data management (UDM) and authentication server function (AUSF). UDM can allow for generation of authentication vectors, user identification handling, NF registration management, and retrieval of UE individual subscription data for slice selection. AUSF performs authentication with UE.

Packet control components can include access and mobility management function (AMF) and session management function (SMF). AMF can receive connection-and session-related information from UE and is responsible for handling connection and mobility management tasks. SMF is responsible for interacting with the decoupled data plane, creating, updating, and removing protocol data unit (PDU) sessions, and managing session context with the user plane function (UPF).

User plane function (UPF) can be responsible for packet routing and forwarding, packet inspection, QoS handling, and external PDU sessions for interconnecting with a data network (DN) (e.g., the Internet) or various access networks. Access networks can include the RAN of cellular network 120.

The 5G core 139 may reside on a cloud computing platform. While from a client's or user's point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

As illustrated in FIG. 1A, the system 100 includes a computing system 150 or data platform. The computing system 150 can be distrusted in some embodiments and include a suite of tools and technologies designed to manage, store, process, analyze, and/or visualize large volumes of data. In varying embodiments, the computing system 150 is located in or implemented as part of the orchestrator 138, is located within the cellular network 120 but outside of the main cellular network components 128, or is located outside of the cellular network 120 but is capable of monitoring data such as capacity information by connecting to the cellular network 120 in similar ways that does a UE. In at least one embodiment, the computing system 150 is a distributed set of processing devices located in one or more of these three locations that can share one or more memory or storage devices that are capable of storing capacity data 152 (see FIG. 1B). In embodiments, the capacity data 152 is associated with bandwidth of various network components (taken alone and in the aggregate in some cases), throughput, network traffic and associated demands for the bandwidth. The computing system 150 can aggregate and track such capacity data 152 for purposes of determining and updating capacity metrics at various layers of the cellular network 120 that informs whether particular network components have (or will have at some point in the future) capacity-related issues that are expected to result in breaks (e.g., dropped calls or dropped network sessions) and the like that result in negative QoS and QoE.

In some embodiments, the computing system 150 is used by modern data-driven organizations, enabling them to harness the power of their data for various purposes, such as business intelligence, analytics, machine learning, and more. In general, the computing system 150 includes components for data ingestion, data storage, data processing, data management, data integration, data analytics, machine learning (ML) and artificial intelligence (AI) platforms, data security, or the like. For example, a data ingestion component can use extract, transform, load (ETL) logic (tools or processes) that extract data from various sources, transform it into a suitable format, and load it into a storage system. The data ingestion component can be set up to stream real-time data from sources, such as Internet of Things (IoT) devices, transactional systems, or other network functions. The computing system 150 can include data storage components, such as data lakes, data warehouses, database systems. Data lakes are large storage repositories that hold raw data in its native format until it is needed. Data warehouses is structured storage systems optimized for query performance and analytics, often storing cleaned and processed data. Database Systems can include both relational (e.g., SQL) and non-relational (e.g., NoSQL) databases for various data storage needs. The data processing components can handle batch processing, streaming processing, or the like. Batch processing can handle large volumes of data in batches, typically for tasks like reporting, data transformation, and aggregation. Stream processing can handle real-time processing of continuous data streams to support applications like real-time analytics and monitoring.

Data management components can handle metadata management and data governance. The metadata management can include tools for managing metadata, which is data about data, including data catalogs, lineage, and governance. Data Governance can include policies and processes to ensure data quality, security, privacy, and compliance with regulations. Data integration components can provide application programming interfaces (APIs), data virtualization, etc. The APIs can be used for accessing and integrating data across different systems. Data Virtualization techniques can be used for abstracting and integrating data from various sources without moving it physically. The data analytics components can have Business Intelligence (BI) and advanced analytics tools and platforms for data reporting, visualization, and dashboards to support decision-making. Advanced analytics techniques, like data mining, predictive analytics, and statistical analysis, can be used to derive deeper insights. The ML/AI platforms can provide a model training platform for developing and training machine learning models using data stored in the platform, and a model deployment platform for deploying trained models into production environments for real-time or batch inference. Data security components can provide access control, encryption, etc. Access control mechanisms can be used for ensuring that only authorized users can access specific data. Encryption techniques can be used for protecting data both at rest and in transit to prevent unauthorized access and breaches.

The computing system 150 can consolidate data from various sources into a single platform, making it easier to manage and access. The computing system 150 can support large-scale data storage and processing, accommodating growing data volumes and increasing complexity. The computing system 150 can enable real-time data processing and analytics, allowing organizations to respond quickly to changing conditions. The computing system 150 can facilitate collaboration across different departments and teams by providing a unified data environment. The computing system 150 can implement data governance and quality control measures to ensure the accuracy and reliability of data. The computing system 150 can provide organizations with the tools and insights needed to make informed, data-driven decisions. In summary, the computing system 150 can provide the infrastructure and tools needed to manage, process, and analyze data effectively, enabling organizations to unlock the full potential of their data assets. The computing system 150 can also provide business intelligence and reporting. The computing system 150 can aggregate data from multiple sources to generate comprehensive reports and dashboards for business analysis. The computing system 150 can provide real-time analytics. In particular, the computing system 150 can monitor and analyze data streams in real-time to gain immediate insights and drive instant actions. The computing system 150 can provide customer insights by analyzing customer data to understand behavior patterns, preferences, and trends to improve customer experience and loyalty. The computing system 150 can implement predictive maintenance as well, such as using machine learning models to predict equipment failures, capacity deficiencies, and schedule proactive capacity solutions and/or maintenance.

FIG. 1B is a block diagram of the computing system 150 of FIG. 1A according to some embodiments. In at least some embodiments, the computing system 150 includes memory 142, a central processing unit (CPU) or other processor, a display device 162, a persistent storage device 164, and a network interface 168. The memory 142 (as well as the persistent storage device 164) can store capacity data 152 and instructions 154. The CPU 160 can include one or more processing devices in the case that the computing system 150 is distributed, while the memory 142 and the persistent storage devices 164 (among other components) may or may not be distributed, e.g., located across different locations of a network such as the cellular network 120 or within the cloud with which the cellular network 120 communicates.

For example, in embodiments, the computing system 150 is implemented in a cloud computing system, providing data storage, data warehousing, real-time data processing, analytic engines for large-scale data processing, ML/AI services, data flow for stream and batch processing, or other data services. As described in more detail below, the computing system 150 can provide and present a GUI 172 within the display device 162 in connection with a capacity planning tool. The capacity planning tool may be instantiated within the instructions 154, which when executed by the one or more processing devices of the CPU 160, presents the GUI 172 with a map and various menus and views associated with the map that will be discussed in more detail hereinafter. In some embodiments, the GUI 172 includes, in connection with the CPU 160, a framework capable of generating and/or modifying executable code (represented by graphical objects in the GUI) for utility programs, applications, functions, routines, scripts, processing pipelines, solutions, connector functions, object stores, enterprise integration tools, or other executable code associated with capacity planning.

As discussed, the capacity data 152 can be associated with bandwidth of various network components (taken alone or in the aggregate in some cases), throughput, and network traffic and associated demands for the bandwidth. The computing system 150 can aggregate and track such capacity data 152 for purposes of determining and updating capacity metrics at various layers of the cellular network 120 that informs whether particular network components have (or will have at some point in the future) capacity-related issues that are expected to result in breaks (e.g., dropped calls or dropped network sessions) and the like that result in negative QoS and QoE. In some embodiments, the capacity metrics are stored in the persistent storage device 164 and, as needed, in the memory 142 when being updated with newly received capacity data 152. In this way, capacity metrics associated with various network components can be updated over time and presented, through various means (such as text box, overlay graphics, and the like) to the GUI 172 as will be discussed.

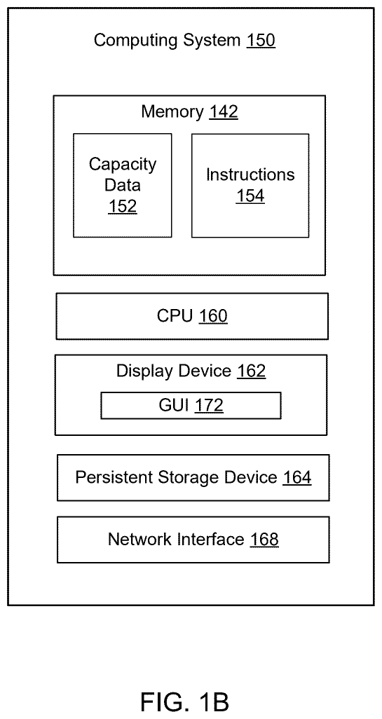

FIG. 2A, FIG. 2B, FIG. 2C, FIG. 2D illustrate a graphical user interface or GUI 200, including a map of an area of interest (AOI) of the cellular network 120, presentable on the display device 162 of the computing system 150 according to at least some embodiments. In some embodiments, the GUI 200 is the GUI 172 discussed with reference to FIG. 1B. The computing system 150 can present, in the GUI 200, a main menu 204, an AOI selector 208, and a cluster selector 212 (FIG. 2A) along with components of the cellular network 120, e.g., which can include a plurality of sites 210 of the cellular network 120.

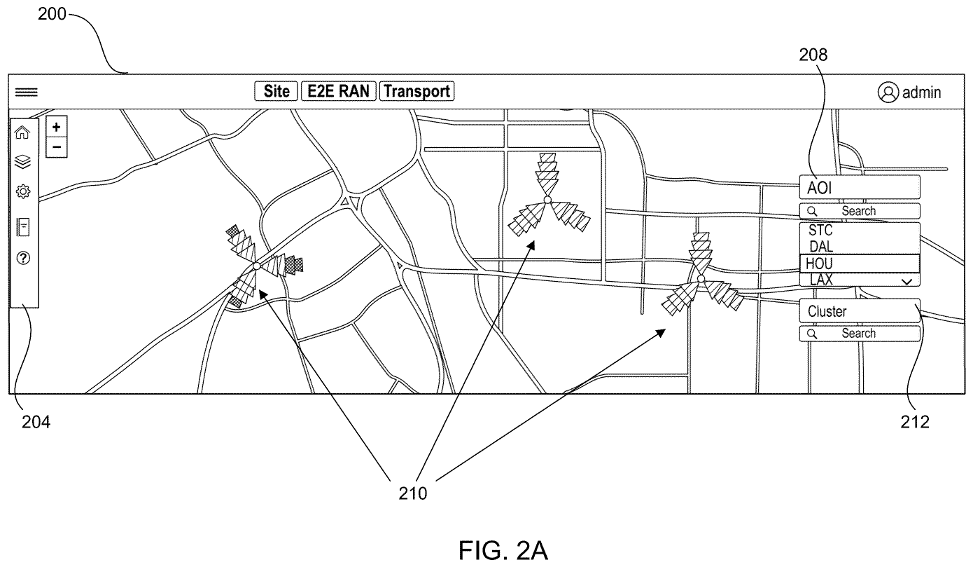

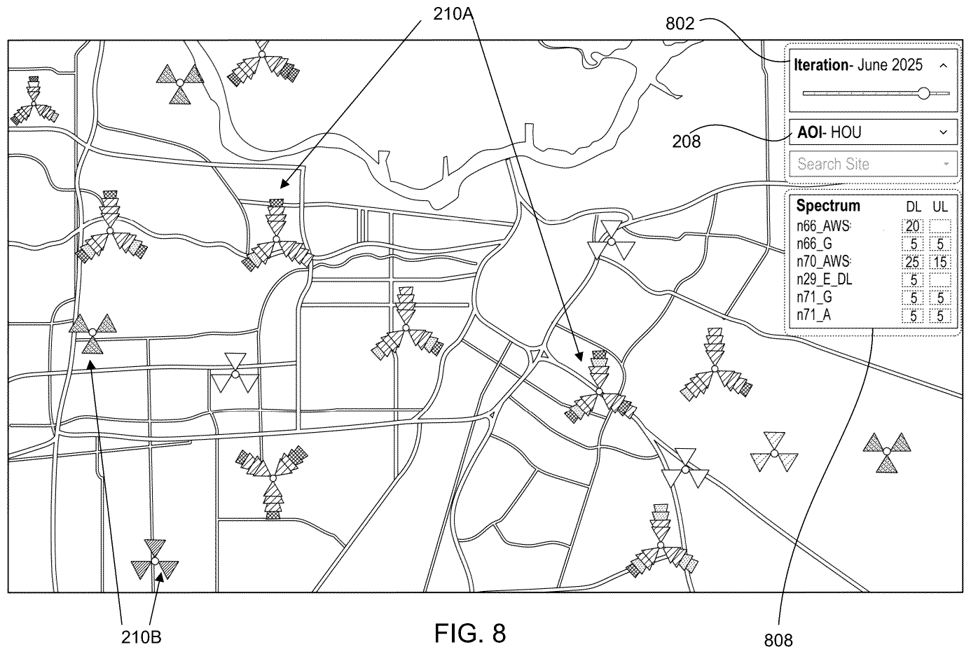

In embodiments, the main menu 204 enables selecting various functionalities or features of the capacity planning tool executed by the computing system 150, e.g., see FIG. 3 and FIG. 10B. These functionalities and features will be discussed in detail as relevant to the present disclosure. For example, a user can select an export icon on the main menu 204 that enables exporting tabular data having selectable views and filters. The tabular data, for example can list component identifier (ID) and corresponding capacity metrics.

The AOI selector 208 may be a drop-down menu of selectable AOIs, which are pulled from a database or data store (e.g., of the persistent storage device 164), and which may be searchable within a separate text input box. As illustrated, the current user has selected Houston (HOU) as the AOI. In embodiments, the cluster selector 212 functions similar to the AOI selector 208, except that a cluster is a subset of the selected AOI and can therefore provide better granularity, e.g., by zooming into a dense cluster of sites within an urban environment for example.

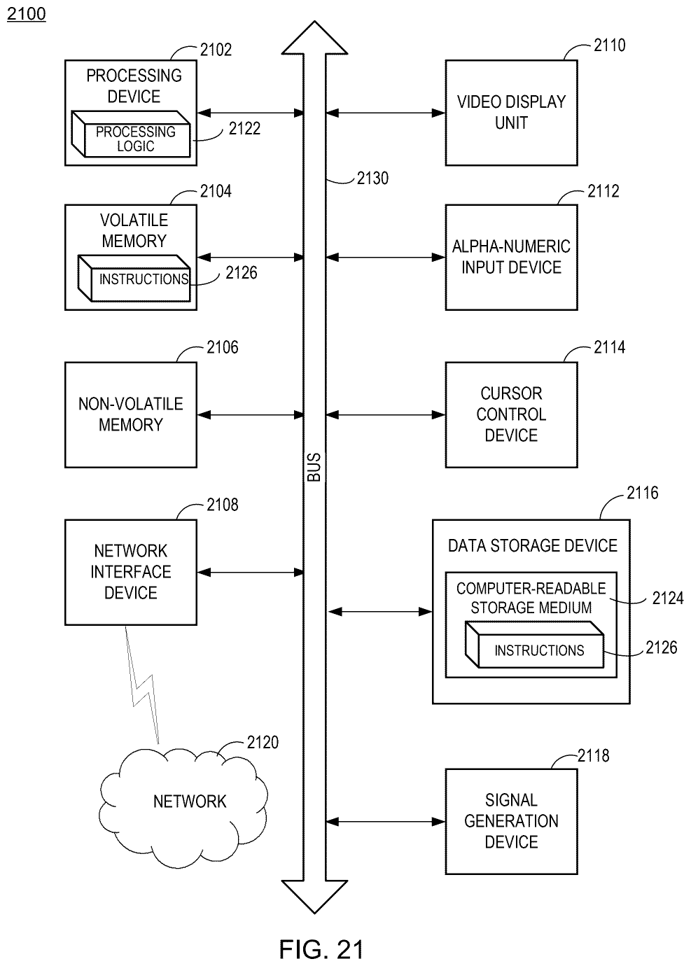

The term “selection” will be referenced throughout this description making reference to use of a cursor or mouse pointer (or the like input/output (I/O) device) of the computing system 150 to select a link, icon, indicator, or other selectable option within the GUI 200. This selection can be performed differently in different embodiments, such as hoovering over or clicking on the option, whether a right click, a middle click, or a left click, as may be available. Different forms of selection may enable access to different types or groups of data or information, to include keyboard or touch screen selection options. Those skilled in the art will recognize other ways that options within a GUI 200 are selected by a user or operator through various I/O devices, some of which are discussed with reference to FIG. 21.

In at least some embodiments, in response to detecting selection of an AOI through the AOI selector, the computing system 150 retrieves (e.g., from the persistent storage device 164) geolocation data for the plurality of sites 210 of the cellular network 120 within the AOI. The computing system 150 can further present, within the GUI 200 over the map, graphical objects representing the plurality of sites 210, e.g., the components of those sites as will be discussed in detail. The graphical objects can include indicators for a plurality of cells of the plurality of sites, as discussed below with reference to FIG. 2B. A user can then zoom in and out to inspect, hover over, or click on the indicators associated with the plurality of sites to perform different functions that will be discussed.

As illustrated in FIG. 2B, the sites 210 can be classified as active sites 210A (e.g., on-air sites) or non-active sites 210B. In various embodiments, a legend 220 can identify what kinds of sites these are by particular shading and how many of each kind exist in the AOI, e.g., via a number in parentheses after the site type in the legend 220. For example, the non-active sites 210B can include sites that are not launched, in-construction, future-builds, or future-builds deferred. The not-launched sites may be construction but not yet active, the in-construction sites not yet fully built, the future-build sites may be allocated for construction, and the deferred sites have been identified but not prioritized (or ranked sufficiently) high to be allocated to be built.

FIG. 2C illustrates a plurality of indicators for any active site 210A presented in the GUI 200 following selection of a particulate AOI. In this example, the active site 210A can include three sectors 225, e.g., a first sector 225A, a second sector 225B, and a third sector 225C. Each sector can be orientated at approximately 120 degrees apart, or other equidistant value to minimize cross-cell interference between sectors, pointing in different directions, referred to as azimuths. Each sector can include multiple cell indicators 230, typically between two and six cell indicators per sector corresponding to the actual cells, which are configurable depending on traffic demand among other factors. As illustrated, the first sector 225A includes a first cell indicator 230A of a first cell, a second cell indicator 230B for a second cell, a third cell indicator 230C for a third cell, and a fourth cell indicator 230D for a fourth cell. Further, a frequency band deployed by each cell in a sector can be a different frequency band to increase overall capacity of the sector. In some embodiments, the a separate cell indicator can be used for a different band if a cell is able to multiplex between bands, for example. In this way, the capacity data can be organized according to sector and cell of each site, the cells within each sector include between two and six different frequency bands.

FIG. 2D illustrates a non-active site 210B, which when selected (e.g., hoovered over or clicked) causes the computing system 150 to present, in the GUI 200, particular site information in a text box 211. This particular non-active site 210B is in construction and is illustrated only by way of example, as each site illustrated on the map, when selected, can present the same or different site information. In this example, the site information in the text box 211 includes a site identifier (ID), a launch category (e.g., build), a year 2024, a status, and other date information, including a projected on-air date.

With additional reference to FIG. 2B, the indicators of each site can be shaded to indicate a capacity status that can be derived from one or more capacity metrics for each respective site, where the indicators relate to cells and/or sectors of each site. For example, as illustrated in the legend 220, the status can include on-air (e.g., is active and functioning with normal capacity), involves a potential break, or is nearing a capacity limit. In embodiments, a potential break can be restated as at least one capacity metric of a plurality of capacity metrics for the cell (or sector) satisfies a predetermined capacity threshold, where satisfying the capacity threshold means meeting or exceeding a value for the capacity threshold. Each capacity metric can be associated with a corresponding predetermined capacity threshold to make this determination. Further, nearing a capacity limit can be restated as at least one capacity metric of the plurality of capacity metrics is within a particular percentage of the predetermined capacity threshold. In this way, satisfying the particular percentage means the capacity metric is nearing the capacity limit, which can be shaded differently.

FIG. 3 is an image of a menu 300 presentable within the GUI 200 as an overlay to the map and that provides selection options of various capacity-related aspects of the cellular network according to some embodiments. For example, a multi-layer icon can be selected from the main menu 204, which causes the menu 300 to pop up over the map listing high-level menu options, such as “Network” (see FIG. 10B) and “Map.” In embodiments, selection of “Map” can cause a drop down of further options, such as map, population, traffic, points of interest, economic value, cellular stores, serving plot, and site ranking, not all of which will be discussed herein. When one of the “Map” options is selected, corresponding graphical indicators and information can be illustrated on the map so that such indicators and information is selectively displayed, to maintain simplicity of what is shown on the map. For example, if too many indicators or too much information is simultaneously displayed, the map would be too congested to meaningfully discern and use the displayed content.

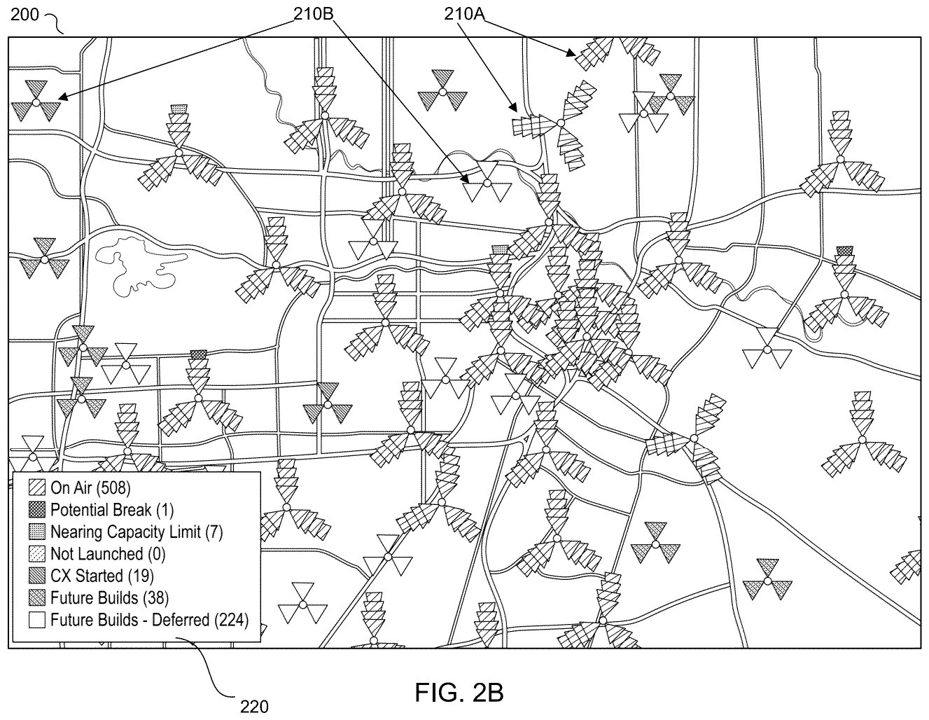

FIG. 4 is a screen capture of the GUI after selection of a site ranking option within the menu 300 of FIG. 3 according to at least one embodiment. In embodiments, the computing system 150 detects selection of a site ranking option at a map pop-up menu, e.g., the menu 300. The computing system 150 can then present, as overlays on the map near respective sites of the plurality of sites, a respective text box 400 including a site score(S) and a site ranking (R) generated based on a plurality of traffic indicators. Not all the sites need necessarily be ranked or some sites will not illustrate the text box 400 if a user has not zoomed in closely enough to force the sites to be separated enough to clearly show all the text boxes 400.

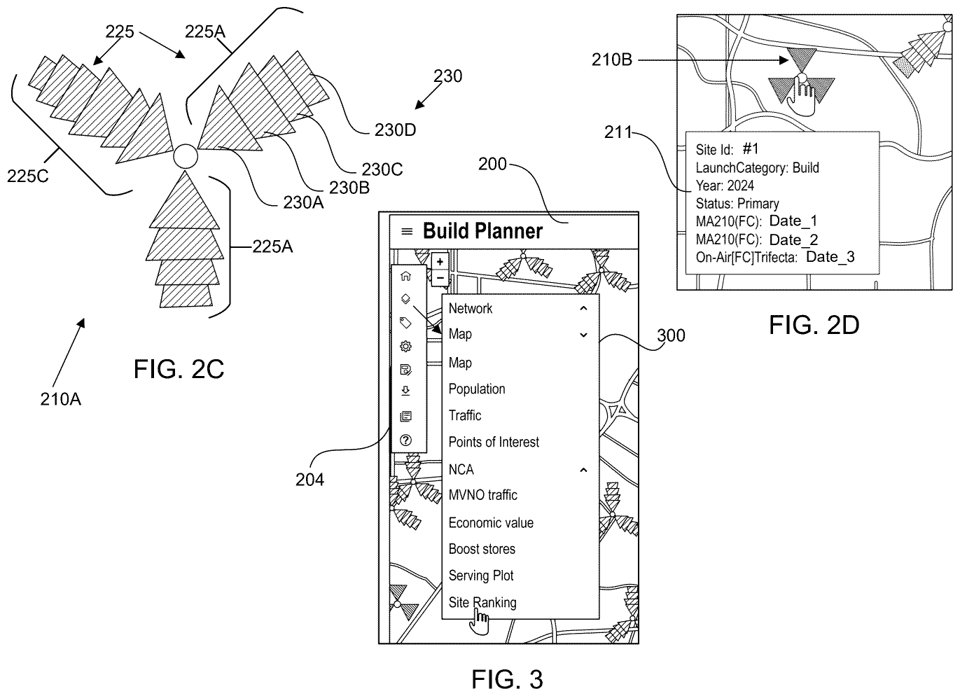

FIG. 5A and FIG. 5B are images each illustrating a build score card overlay that can be presented within a pop-up window to illustrate the detail of one of the site rankings illustrated in FIG. 4 according to two embodiments. For example, illustrated in FIG. 5A is a first build score card overlay 500A having a high score and illustrated in FIG. 5B is a second build score card overlay 500B having a lower score relative to the high score of FIG. 5A. In embodiments, the computing system 150 detects selection of a text box 400 displayed adjacent to a site of the plurality of sites. In response to the detection, the computing system 150 can illustrate, in a build score card overlay, the site ranking and the plurality of traffic indicators. In some embodiments, the traffic indicators mentioned with reference to FIG. 4 include population data, roaming traffic data, cellular stores information, competition data, and/or nearby highways information.

In various embodiments, the computing system 150 determines the score for each site as a combination of weighted values corresponding to the plurality of traffic indicators, e.g., nearby population levels, amounts of roaming traffic, nearby cellular stores, number of nearby competitor cellular sites (or towers), and number of nearby highways. The nearby cellular stores can refer to retail stores that sell subscriber identity module (SIM) cards for UEs to connect to the cellular network 120 (FIG. 1).

Once a score is determined for each site based on such traffic indicator criteria, the computing system 150 can rank and prioritize the sites based on these scores as well as additional criteria, such as build progress of sites in the AOI, performance and customer experience, financial impact of each site, and overall economic value imparted by the site to prospective users. There may exist hundreds of planned sites that are not ranked and/or prioritized enough to be scheduled for construction. The computing system 150 can then tag each site according what is currently planned for that site, which in turns causes the site indicators to be shaded according to such planning as we discussed with reference to the legend 220 of FIG. 2B, e.g., as not launched, construction started, future build, or future build deferred for sites not already active. The scoring, ranking, and site tagging can be periodically updated and to stay up to date on meeting capacity demands throughout various AOIs.

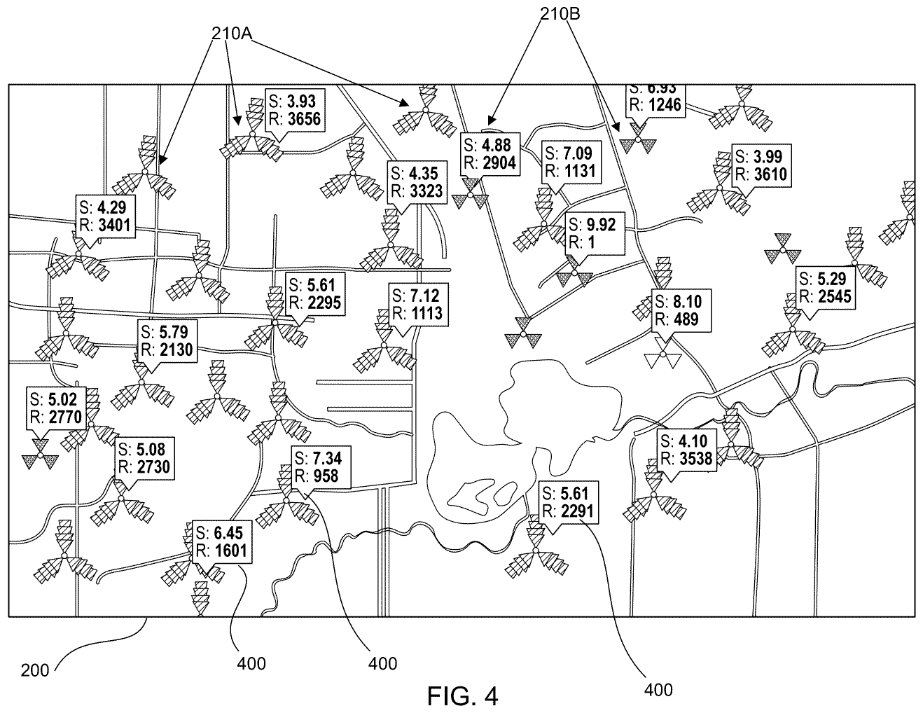

FIG. 6 is an image of a metric overlay 600 of capacity metrics presented within a pop-up window in response to selection of a cell indicator 630 of a cell of a site 610 according to at least one embodiment. In embodiments, the computing system 150 detects selection of the indicator of a cell of the plurality of cells of a site, e.g., the site 610 which is an active site in this example. In embodiments, the computing system 150 illustrates or populates, in the metric overlay 600 on the map, the plurality of capacity metrics with corresponding values. Capacity metrics can also be referred to as key performance indicators (KPIs) related to network capacity as that term was previously explained.

In various embodiments, illustrated in the columns of the metric overlay 600, the capacity metrics include cell uplink throughput, cell downlink throughput, total physical resource block (PRB) usage (e.g., in the downlink and the uplink), a number of radio resource control (RRC) connections, and/or a user equipment (UE) throughput for cell downlinks. In 5G, PRB is the smallest unit of resources that can be allocated to a user for data transmission. In embodiments, PRBs include multiple subcarriers and time slots and are used to allocate bandwidth to users, optimizing the use of the available spectrum. Further, RRC is a protocol used in mobile networks, including 5G, to manage the connection between a UE and the network. Thus, RRC connections can handle the setup, maintenance, and release of the network connections, as well as the allocation of radio resources to ensure efficient communication.

Associated with these capacity metrics, as reflected in the metric overlay 600, include a value for the metric (illustrated in the “Loading” column as a percentage of a capacity limit), a backhaul (BH) value, capacity limit value for each illustrated capacity metric, and element configurations for the cellular component. As to the latter, the computing system 150 can illustrate, in the metric overlay 600, a plurality of element configurations and corresponding values including a frequency band name, a mechanical tilt, a vendor, an upload bandwidth, a download bandwidth, an azimuth, an electrical tilt, and/or a height. Note that the value for the PRB capacity metric is at 95.87%, quickly informing an operator that the PRB usage is why the cell indicator 630 is shaded indicating satisfaction of a predetermined capacity threshold for PRB usage.

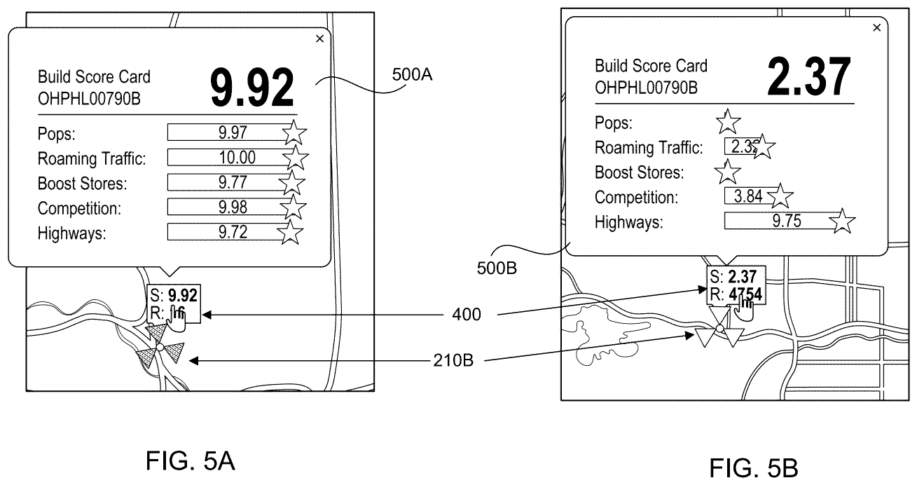

FIG. 7 is an image of a metric overlay 700 of capacity metrics presented within a pop-up window in response to selection of a sector-level indicator 725 of a site 710 according to an embodiment. Thus, capacity data can be organized according to sector and cell of each site. In embodiments, the computing system 150 detects selection of the indicator 725 of a sector of the plurality of cells of a site, e.g., the site 710, which is an active site in this example. In embodiments, the computing system 150 illustrates, in the metric overlay 700 on the map, the plurality of capacity metrics, with corresponding values. Capacity metrics can also be referred to as key performance indicators (KPIs) related to network capacity as that term was previously explained.

In various embodiments, illustrated in the columns of the metric overlay 700, the capacity metrics include cell uplink throughput, cell downlink throughput, total PRB usage (e.g., in the downlink and the uplink), a number of RRC connections, and/or a UE throughput for cell downlinks. Associated with these capacity metrics include a value for the metric (illustrated in the “Loading” column as a percentage of a capacity limit), a backhaul (BH) value, capacity limits for capacity metric, and an element configurations. Note that the value for the number of RRC connections is at 116.58%, which would surely satisfy a predetermined capacity threshold for this particular metric. An operator can quickly inspect the metric overlay 700 to determine why the indicator 725 is shaded as a potential break in network connection due to being overloaded with RRC connections.

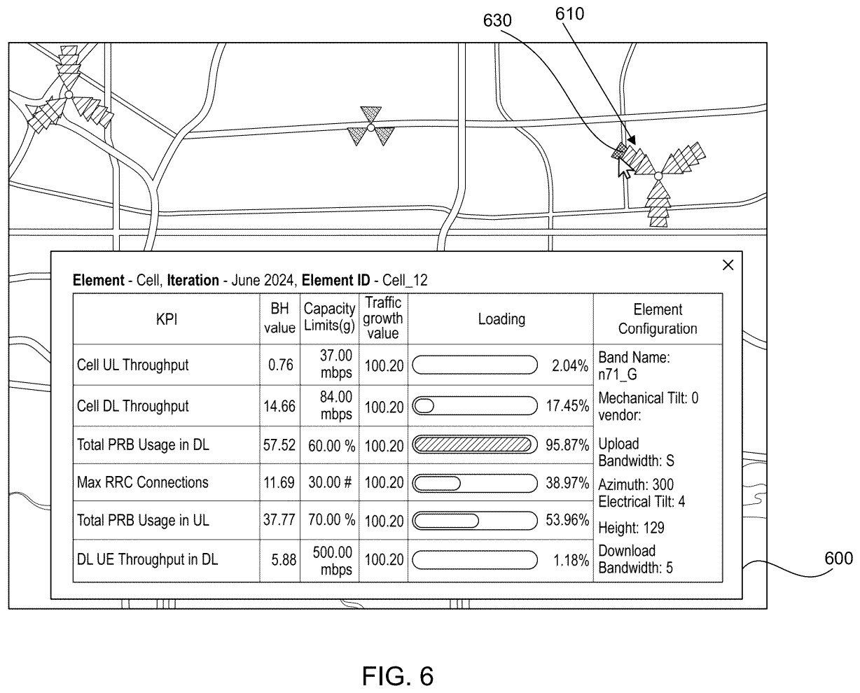

FIG. 8 is a screen capture of the GUI 200 including a date selector 802 presented as an overlay within a selection window according to some embodiments. The screen capture also illustrates a spectrum summary 808 that includes a list available frequency bands. In embodiments, the computing system 150 can present, within the GUI 200, the list of available frequency bands in both downlink and uplink directions. In embodiments, having additional frequency bands available at different locations can enable flexibility in addressing capacity deficiencies at particular sectors of the various sites of the AOI.

In some embodiments, the date selector 802 can be selected and adjusted to a future date, e.g., a future iteration of an AOI build out. Thus, the computing system 150 can, in response to receiving an input selection of the date selector to a future date through the date selector 802, analyze the capacity data to predict a plurality of capacity metrics at the future date for the plurality of sites in the AOI. The computing system 150 can further change shading of at least one indicator, corresponding to a cell of the plurality of cells, indicating that at least one capacity metric of the plurality of capacity metrics for the cell satisfies a predetermined capacity threshold.

In this way, the GUI 200 and functionality of the capacity planning tool running on the computing system 150 provides simulation capability to project capacity issues into the future. An operator can quickly see new cell indicators change shade to know that a cell associated with each newly shaded indicator is predicated to have capacity issues at the selected future date. The operator could then click on individual shaded indicator to see the projected capacity metrics at that future date or choose to export tabular data of the capacity metrics, e.g., into a single table or report for analysis. As will be discussed in more detail later, this data could also be analyzed in order to suggest to an operator a design change be made in one or more impacted sites as suggested solutions to these capacity issues.

In some embodiments, the computing system 150 presents sector-level indicators for a plurality of sectors of the plurality of sites, such as the indicator 725 of FIG. 7. In response to receiving an input selection of the date selector 802 to a future date, the computing system 150 changes shading of at least one sector-level indicator for a sector of the plurality of sites. In embodiments, the changed shading is indicative of the at least one capacity metric of the plurality of capacity metrics for the sector satisfying a second predetermined capacity threshold that is larger than the predetermined capacity threshold.

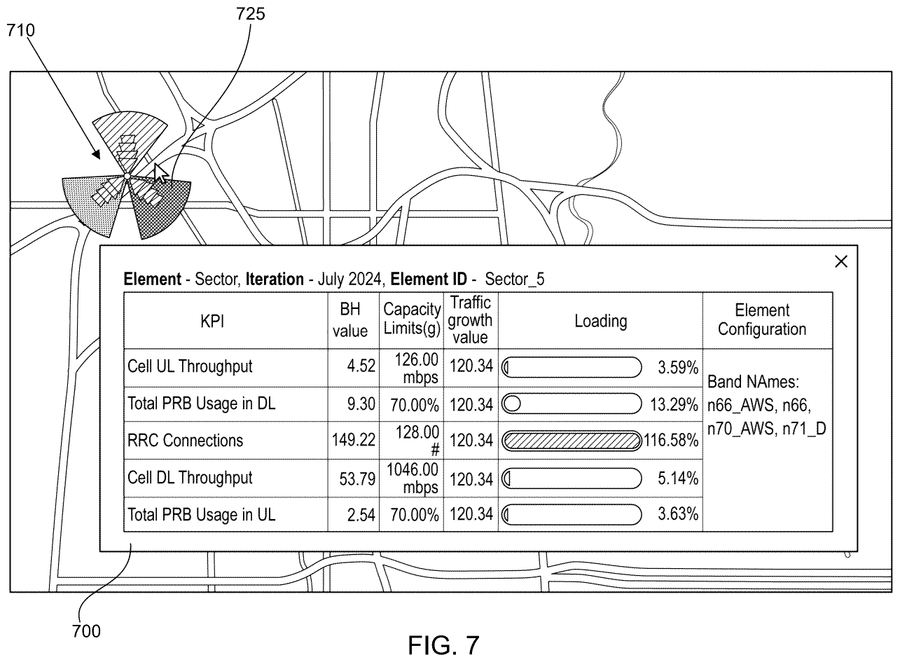

FIG. 9 is a flow chart of a method 900 of illustrating components of a cellular network and predicting capacity metrics of those components at a future time according to at least one embodiment. The method 900 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 900 is performed by the computing system 150 of FIGS. 1A-1B with the GUI of the foregoing Figures. The method 900 can also be performed by other computing systems described herein, such as in FIG. 21.

At operation 910, the processing logic presents (e.g., in a display device) a graphical user interface (GUI) including a map, an area of interest (AOI) selector, and a date selector.

At operation 920, in response to detecting selection of an AOI through the AOI selector, the processing logic, at operation 925, retrieves geolocation data for a plurality of sites of the cellular network within the AOI. At operation 930, the processing logic presents, within the GUI over the map and consistent with the geographical data, graphical objects representing the plurality of sites. In embodiments, the graphical objects include indicators for a plurality of cells of the plurality of sites.

At operation 940, in response to receiving an input selection of the date selector to a future date, the processing logic, at operation 945, analyzes the capacity data to predict a plurality of capacity metrics at the future date for the plurality of sites. At operation 950, the processing logic changes shading of at least one indicator, corresponding to a cell of the plurality of cells, indicating that at least one capacity metric of the plurality of capacity metrics for the cell satisfies a predetermined capacity threshold.

In embodiments, the predetermined capacity threshold is associated with a significant capacity deficiency or inability to stay connected to the cellular network, such that corrective action is (or soon will be) necessary. Each capacity threshold can be programmable for different capacity metrics and adjusted over time. In this way, engineers and other operators can quickly detect where, within the AOI of the cellular network, particular levels of capacity-related issues exist and seek to address those issues.

In some embodiments, the method 900 also includes changing shading of at least a second indicator, corresponding to a second cell of the plurality of cells, indicating that at least one capacity metric of the plurality of capacity metrics is within a particular percentage of the predetermined capacity threshold.

FIG. 10A is a screen image of a GUI 1000 after selection, within an input selector window, of various components of the cellular network 120 according to some embodiments. In some embodiments, the GUI 1000 is the same as the GUI 200 of FIG. 2 and some components are similarly or identically labeled as in FIG. 2. FIG. 10B is an image of an exemplary input selector window 1005 within the GUI 1000 from which to select the various components according to some embodiments. For example, the input selector window 1005 includes check boxes for various cellular components of the cellular network 120, to include cells 230, sectors 225 (see FIG. 2C), centralized units (or CUs 1050), distributed units (or DUs 1040), cell site routers (CSRs), front-haul segments 1060 (or FHs), and mid-haul segments 1070 (or MHs). In embodiments, each DU 1040 is assigned an ID and each CU 1050 is assigned an ID by which network traffic can be tracked and directed by the CSRs.

In some embodiments, in response to detecting, through the input selector window, selection of one or more component types of the plurality of component types, the computing system 150 retrieves geolocation data for a plurality of components corresponding to the selected one or more component types. The computing system 150 can then present, within the GUI 1000 over the map, graphical objects representing the plurality of components consistent with the geolocation data. The computing system 150 can then retrieve capacity data associated with the plurality of components. The computing system 150 can then shade, based on the capacity data, each graphical object to indicate a capacity status associated with each corresponding component of the plurality of components.

For example, as illustrated in the legend 220, the status can include on-air (or being active and functioning with normal capacity), involves a potential break, or is nearing a capacity limit. In embodiments, a potential break can be restated as at least one capacity metric of a plurality of capacity metrics for the cell (or sector) satisfies a predetermined capacity threshold, where satisfying the capacity threshold means meeting or exceeding a value for the capacity threshold. Each capacity metric can be associated with a corresponding predetermined capacity threshold to make this determination. Further, nearing a capacity limit can be restated as at least one capacity metric of the plurality of capacity metrics is within a particular percentage of the predetermined capacity threshold. In this way, satisfying the particular percentage means the capacity metric is nearing the capacity limit, which can be shaded differently.

In some embodiments, when the one or more component types are selected from the input selection window 1005, presenting the graphical objects within the GUI 1000 includes presenting a subset of cells for each site, a plurality of DUs 1040, at least one CU 1050, a plurality of front-haul segments connecting each site to a respective DU 1040, and a plurality of mid-haul segments connecting each DU 1040 to the at least one CU 1050.

In one or more menu sections the GUI 1000 can also include the AOI selector 208, the cluster selector 212, a date selector 1002 such as the date selector 802 (but presenting a selection of future date on a quarterly basis), and a component selector 1014 adapted for selection of a site, sector, or cell of the site. In some embodiments, the computing system 150 presents the AOI selector 208 in the GUI 1000. In response to detecting selection of an AOI, through the AOI selector 208, the computing system 150 can retrieve the geolocation data and the capacity data from a database portion that is specific to the AOI, e.g., from the memory 142 and/or persistent storage device 164. The computing system 150 can then present, within the GUI 1000 over the map, graphical objects representing the plurality of components consistent with the geolocation data, as illustrated in FIG. 10A.

In some embodiments, in response to detecting selection of a graphical object of the graphical objects, the computing system 150 determines, using the capacity data, a plurality of capacity metrics associated with the graphical object. The computing system 150 can further present, within the GUI 1000 as an overlay of the map, a text box including values for the plurality of capacity metrics. Providing such capacity metric values was discussed by way of example with reference to FIG. 6 for cells 230 and FIG. 7 for sectors.

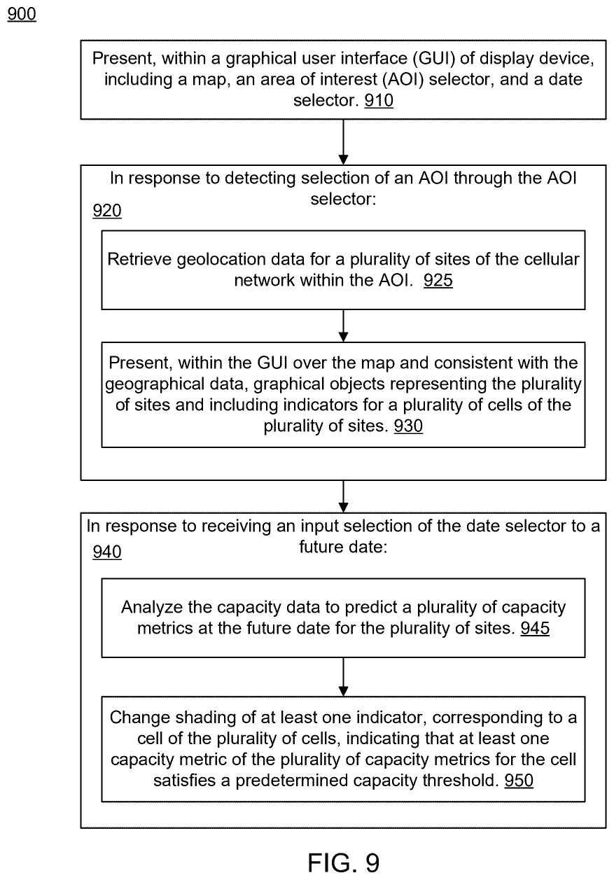

FIG. 11 is an image of a metric overlay 1100 of capacity metrics within a pop-up window in response to selection of a DU 1040 component of the cellular network 120 according to at least one embodiment. For example, in embodiments, the graphical object that is selected corresponds to a DU 1040 and the plurality of capacity metrics include cell throughput for uplinks, total physical resource block (PRB) usage percent in downlinks, a maximum number of radio resource control (RRC) connections, cell throughput for downlinks, and/or total PRB usage percent in uplinks. In the element configuration space, the metric overlay can further include total cells and server type of the DU 1040.

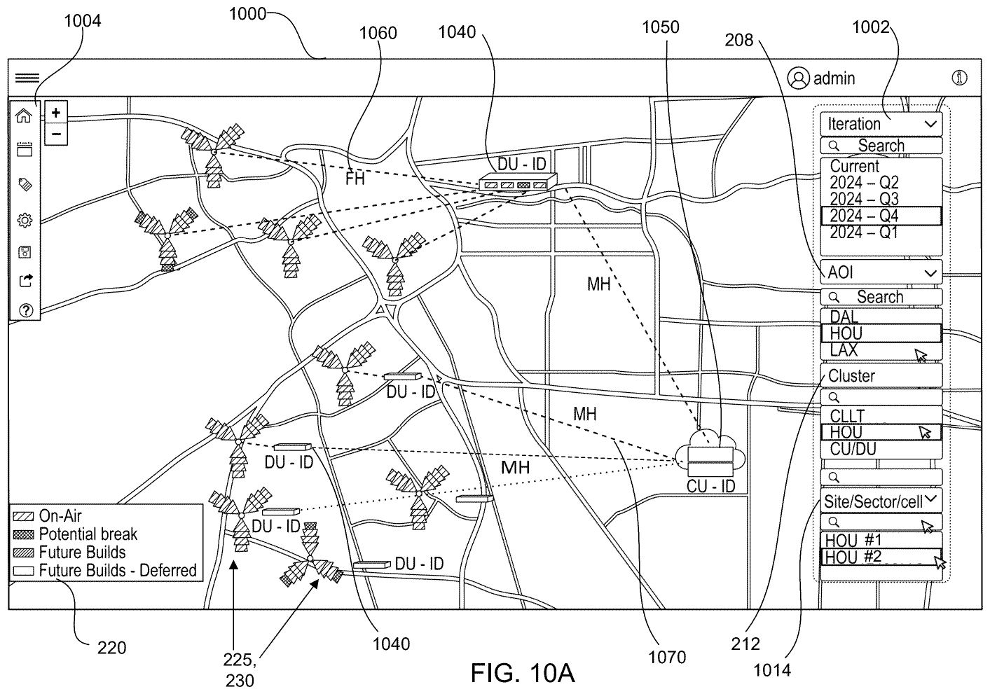

FIG. 12 is an image of a metric overlay 1200 of capacity metrics within a pop-up window in response to selection of a centralized unit (CU) component of the cellular network according to at least one embodiment. For example, in embodiments, the graphical object that is selected corresponds to a CU 1050 and the plurality of capacity metrics includes a DU count threshold number, a cell count threshold number, a maximum number of radio resource control (RRC) connections, and a cell throughput for downlinks.

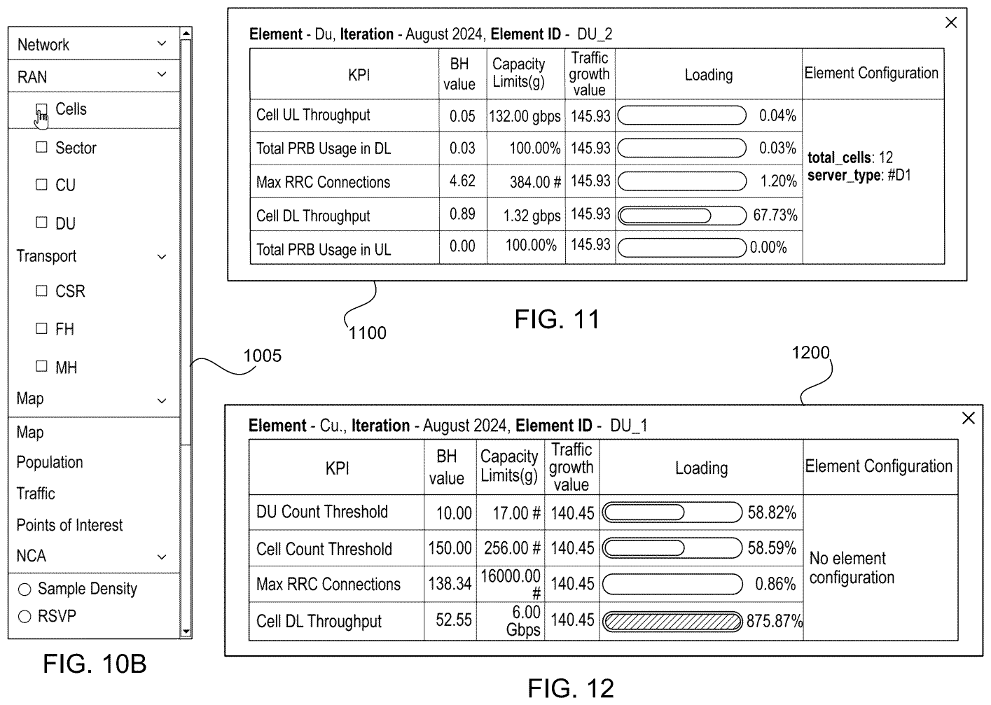

FIG. 13 is an image of a metric overlay 1300 of capacity metrics within a pop-up window in response to selection of a front-haul segment component of the cellular network according to at least one embodiment. For example, in embodiments, the graphical object corresponds to a front-haul segment 1060 and the plurality of capacity metrics includes interface transmission throughput, interface transmission link utilization, interface reception throughput, and/or interface reception link utilization.

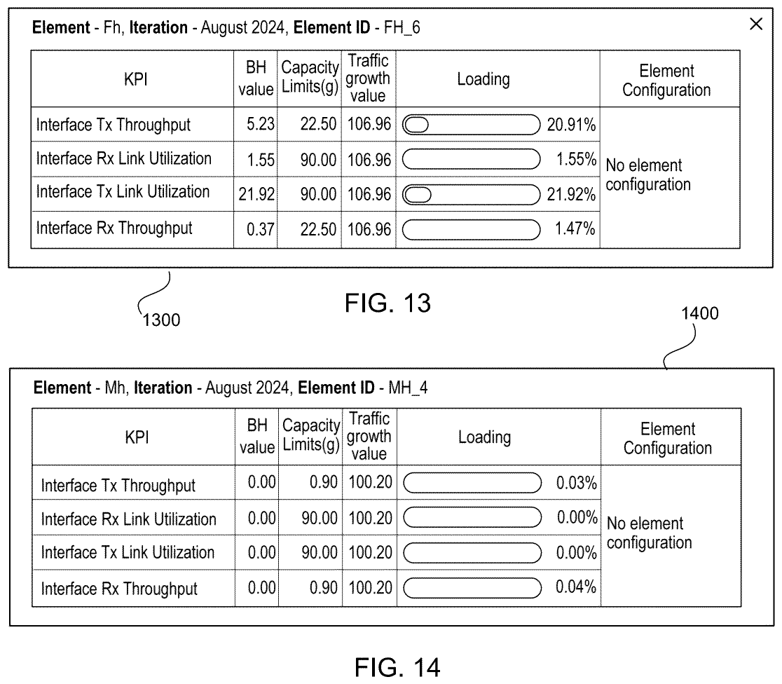

FIG. 14 is an image of a metric overlay 1400 of capacity metrics within a pop-up window in response to selection of a mid-haul segment component of the cellular network according to at least one embodiment. For example, in embodiments, the graphical object corresponds to a mid-haul segment 1070 and the plurality of capacity metrics includes interface transmission throughput, interface transmission link utilization, interface reception throughput, and/or interface reception link utilization.

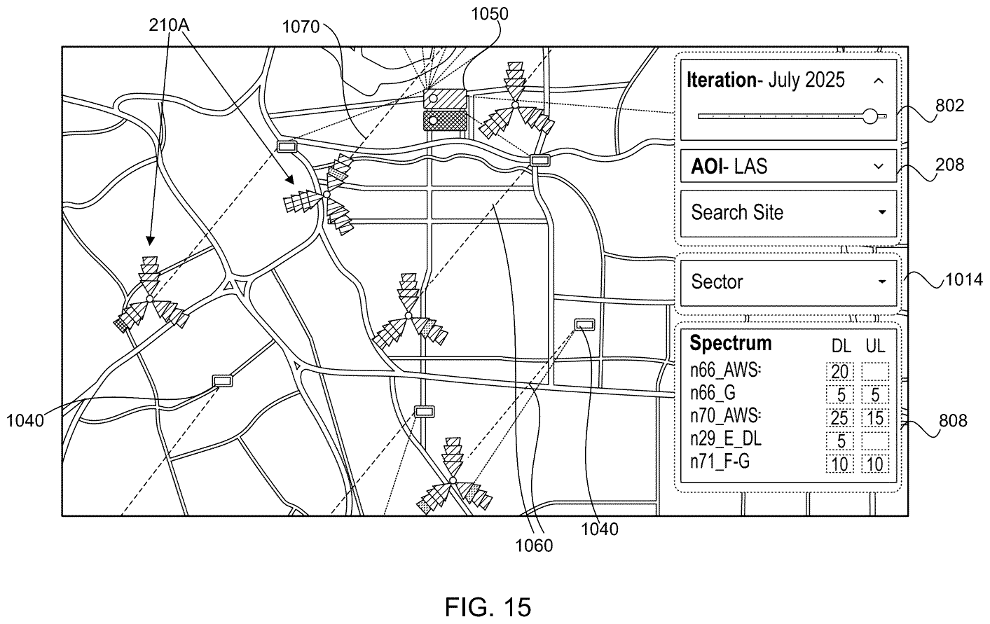

FIG. 15 is a screen capture of the GUI 1000, which presents the components as graphical objects and the date selector 802 as an overlay within a selection window according to some embodiments. In some embodiments, the capacity status is one of on-air, satisfies a predetermined capacity threshold, or is within a particular percentage of the predetermined capacity threshold. In embodiments, the computing system 150 presents, within the GUI 1000, the date selector 802. In response to receiving an input selection of the date selector 80 to a future date, the computing system 150 analyzes the capacity data to predict a plurality of capacity metrics at the future date for the plurality of components. The computing system 150 can further change shading of at least one graphical object, corresponding to a component of the plurality of components, indicating that at least one capacity metric of the plurality of capacity metrics for the component has a changed capacity status.

In this way, the capacity planning tool executed by the computing system 150 can identify changes from an active (or on-air) status to a potential break or nearing capacity limit status. In embodiments, a potential break can be restated as at least one capacity metric of a plurality of capacity metrics for the cell (or sector) satisfies a predetermined capacity threshold, where satisfying the capacity threshold means meeting or exceeding a value for the capacity threshold. Each capacity metric can be associated with a corresponding predetermined capacity threshold to make this determination. Further, nearing a capacity limit can be restated as at least one capacity metric of the plurality of capacity metrics is within a particular percentage of the predetermined capacity threshold. In this way, satisfying the particular percentage means the capacity metric is nearing the capacity limit, which can be shaded differently.

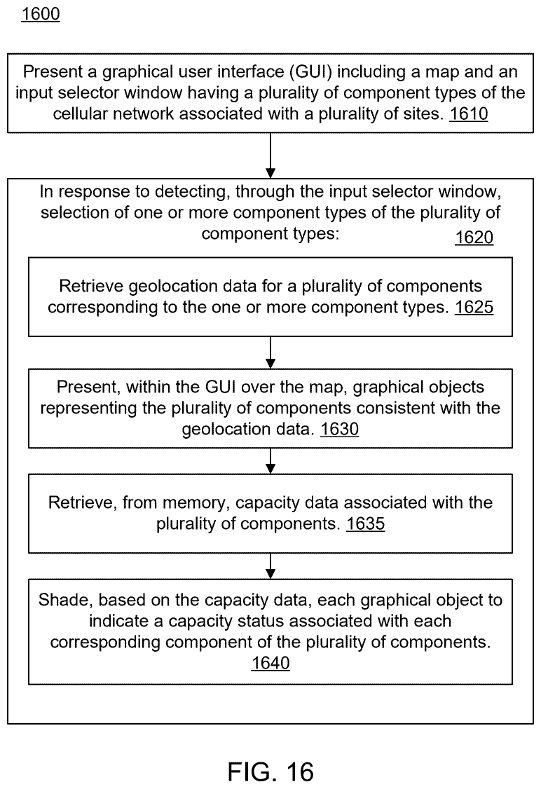

FIG. 16 is a flow chart of a method 1600 of illustrating components of a cellular network and illustrating graphical objects in a way that is representative of capacity status according to at least one embodiment. The method 1600 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 1600 is performed by the computing system 150 of FIGS. 1A-1B with the GUI of the foregoing Figures. The method 1600 can also be performed by other computing systems described herein, such as in FIG. 21.

At operation 1610, the processing logic presents (e.g., in a display device) a graphical user interface (GUI) including a map and an input selector window having a plurality of component types of the cellular network associated with a plurality of sites.

At operation 1620, in response to detecting, through the input selector window, selection of one or more component types of the plurality of component types, the processing logic can perform at least operations 1625 through 1640.

At operation 1625, the processing logic retrieves geolocation data for a plurality of components corresponding to the one or more component types.

At operation 1630, the processing logic presents, within the GUI over the map, graphical objects representing the plurality of components consistent with the geolocation data.

At operation 1635, the processing logic retrieves capacity data associated with the plurality of components.

At operation 1640, the processing logic shades, based on the capacity data, each graphical object to indicate a capacity status associated with each corresponding component of the plurality of components.

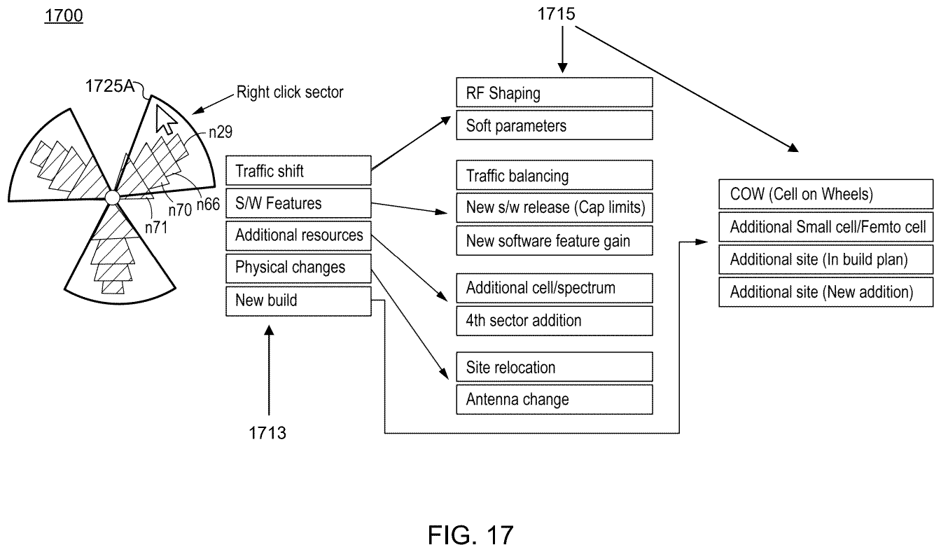

FIG. 17 is an operational flow diagram 1700 associated with a solutions dropdown menu, upon selecting a component of a site, to make design changes to the component according to some embodiments. For example, when the capacity planning tool is put into a solutions planning mode, the computing system 150 can monitor for particular selection actions taken with reference to the graphical objects of cellular components of a plurality of sites of an AOI. In at least some embodiments, in response to detecting selection of a graphical object associated with a component of the plurality of components, the computing system 150 presents a solutions dropdown menu 1713 listing design changes available to the component.

In the illustrated embodiment, by way of example, the graphical object represents a first sector 1725A and the selection is a right click, but other selection actions are envisioned. Once the graphical object is selected, the solutions dropdown menu 1713 illustrates different design changes that an operator can make, e.g., a traffic shift, an update to software features, additional resources to a site, physical changes to a site, or a new build, e.g., adding a new site. The design changes, in some embodiments, is a list of design change categories. In some embodiments, the computing system 150 makes the solutions dropdown menu 1713 available only to a subset of the plurality of components for which at least one value of a plurality of metrics, for the component, satisfies a predetermined capacity threshold (e.g., is considered a potential break) or is within a particular percentage of the predetermined capacity threshold (e.g., is nearing a capacity limit).

In some embodiments, in response to detecting selection of a particular design change through the solutions dropdown menu 1713, the computing system 150 retrieves capacity data associated with the component (e.g., the first sector 1725A) and receives an input value associated with the particular design change, e.g., via a text entry box, another dropdown menu with selectable values or options, or other GUI data input objects. The computing system 150 can then determine, based on the capacity data and the input value, updated values of a plurality of capacity metrics for at least the component of the plurality of components. In some embodiments, the computing system 150 determines the plurality of capacity metrics for at least some of the plurality of components that are impacted by the input value, for example.

The computing system 150 can then present, within the GUI 1000, the updated values and the plurality of capacity metrics associated with the at least some of the plurality of components, e.g., see capacity metrics of FIG. 6-7, FIGS. 11-12, and FIGS. 13-14. Further, the computing system 150 can also update the shading of the impacted component indicators, for example, a cell indicator can be changed from indicating a potential break to nearing a capacity limit or being fully active (e.g., on-air), the latter of which indicates no capacity issues. Similarly, only by way of example, the cell indicator could be changed from indicating nearing a capacity limit to being fully active. These are streamlined ways (akin to simulation) to communicate to an operator that the targeted capacity issues have been resolved using the solutions dropdown menu 1713 and associated processing by the computing system 150.

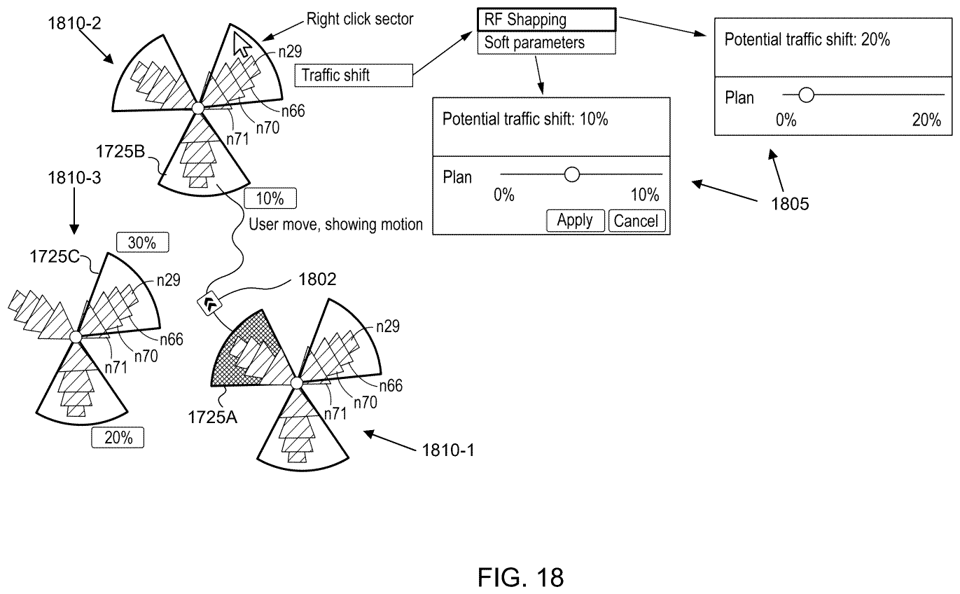

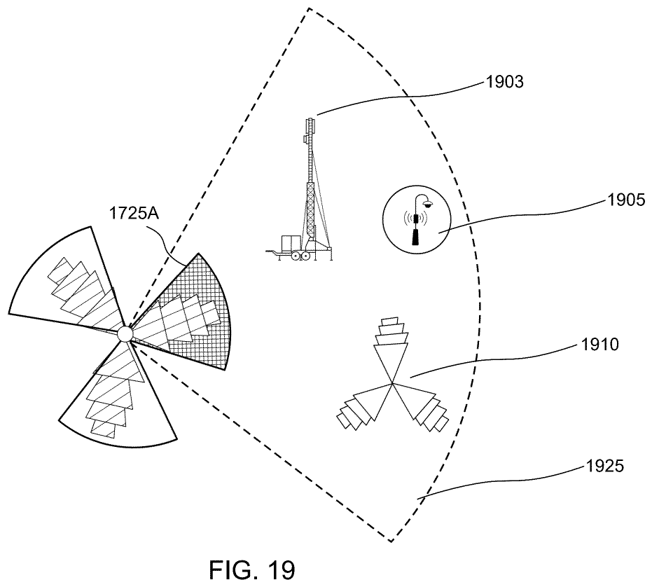

In some embodiments, upon detecting selection of a particular design change (or design change categories) in the solutions dropdown menu 1713, the computing device presents a design change sub-menu 1715 with a list of specific design changes corresponding to the selected design change category. For example, in response to selection of a traffic shift category (see FIG. 18), the design change sub-menu 1715 can include RF shaping and soft parameters design changes. Further, in response to selection of a software features category, the design change sub-menu 1715 can include traffic balancing, installation of a new software release (which by itself can increase capacity), and a new software gain feature. Further, in response to selection of additional resources, the design change sub-menu 1715 can include additional cells or spectrum and addition of a fourth sector. Further, in response to selection of physical changes, the design change sub-menu 1715 can include site relocation and an antenna change. Finally, in response to selection of a new build, the design change sub-menu 1715 can include a cell on wheels (see FIG. 19), the addition of a small cell (or femtocell), an additional site (in-build plan), and an additional site (complete new addition).

In some alternative embodiments, the computing system 150 analyzes the capacity data associated with the cellular components and elements, identifies capacity-specific issues based on a particular capacity metric satisfying a predetermined capacity threshold for that capacity metric, and recommends, through the GUI 1000 to the operator, to make a design change that will reduce that capacity metric so that the capacity metric does not satisfy the predetermined capacity threshold. For example, the computing system 150 can highlight the text of the design change, place a check next to the particular design change, or otherwise call attention to the operator, through the GUI 1000, that the particular design change should be considered as a solution to an identified capacity-specific issue.

Once one of the specific design changes is selected, the computing system 150 can present in the GUI a text box, a selection icon or slider, or the like from which to receive an input value corresponding to the particular design change being requested. The computing system 150 can then recalculate at least some of the capacity metrics for impacted cellular components based on the particular design change, thus simulating whether the particular design change resolves a real or potential capacity deficiency in the cellular network 120. For example, the computing system 150 can retrieve and update capacity metrics from a central datasheet, which is then employed for recalculating the capacity metrics based on solution-based value changes to at least one capacity metric of at least one cellular component. This ability of the computing system 150 can significantly streamline the determination of which proposed design changes resolve capacity deficiencies and those that do not.

In some embodiments, an operator of the capacity planning tool has the ability to implement the same solution for the entire AOI and get the new capacity metrics calculated. To do so, the operator can right click (or employ a predetermined selection option) on a design change and select “apply for all cells/sectors within the AOI.” As example, an additional frequency bands will be for all sites/cells in the AOI, so all of the sites will have a cell added and gain calculated. Or, in embodiment, the user uploads a list of cells to which the design change is to be implemented.

FIG. 18 is a set of images of graphical objects representing neighboring sites and operational flow of shifting traffic between sectors of the neighboring sites according to some embodiments. For example, as illustrated, the GUI 1000 can include a first site 1810-1 having the first sector 1725A, a second site 1810-2 having a second sector 1725B, and a third site 1810-3 having a third sector 1725C, where each of the first sector 1725A, the second sector 1725B, and the third sector 1725C are oriented to generally the same area, e.g., have overlapping coverage. In this way, the sectors can share traffic and be amenable to shifting traffic between each other. As illustrated, the first sector 1725A is shaded to indicate having at least once capacity metric that satisfies a predetermined capacity threshold. One solution to this problem can be to shift traffic from the first sector 1725A to one or both of the second sector 1725B or the third sector 1725C.

In embodiments, in response to detecting selection of the traffic shift option in the design change menu 1713 associated with the first sector 1725A, the computing system 150 presents, near the selected graphical object, a traffic shift indicator 1802. The traffic shift indicator 1802 can be dragged by a cursor to hover over or be near the second sector 1725B of the second site 1810-2 and/or the third sector 1725C of the third site 1810-3, in response to which the computing system 150 can present, in the GUI 1000, a percentage of potential traffic shift, e.g., how much traffic shift is available to be shifted to the other sector. The potential traffic shift can be retrieved from a capacity metric database stored in the persistent storage device 164, for example. In embodiments, each source sector and target sector can have a potential value for the shift that is pre-calculated in the source and target tabs of the database.

In some embodiments, each sector has a potential to move traffic to at least three sectors as per the source and target sheet, those are predefined data with logic. The potential three sectors can be highlighted in the map with the potential percentage to shift, so the user knows to where and how much the traffic can be shifted or moved. Upon dropping the traffic shift indicator 1802 on the second sector 1725B of the second site 1810-2, for example, the computing system 150 can present a slider bar 1805 that can be adjusted to choose a precise amount (or percentage) or traffic to shift to the second sector 1725B. The maximum position of the sliding bar 1805 can match the potential shift value to that sector, e.g., the second sector 1725B. In some embodiments, the amount of traffic available for shifting may depend on whether the shift is for RF shaping or other soft parameters. RF shaping may refer to adjusting physical parameters of an antenna to shape the electromagnetic radiation RF shape, e.g., by changing an electronic tilt, mechanical tilt, azimuth, and/or height of the antenna. The soft parameters can refer to a minimum power level needed to connect to the cell (which effectively sets or limits the distance between cells and the farthest connectable UEs), an idle or active mobility threshold, and a carrier aggregation tuning with downlink cells, or the like.

In various embodiments, with continued reference to FIG. 18, the computing system 150 detects, in association with the particular design change, selection of the first sector 1725A of the first site 1810-1 and the second sector 1725B of the second site 1810-2 of the plurality of sites. The computing system 150 can present, within the GUI 1000, the traffic shift indicator 1802 associated with the first site 1725A and the second site 1725B. The computing system 150 can detect, via movement of the traffic shift indicator, a particular percentage of traffic planned to be shifted from the first sector 1725A to the second sector 1725B, as was just described. For example, the movement of the traffic shift indicator can also include a finer selection of the amount of traffic shift via the slider bar 1805. In embodiments, the computing system 150 can perform a similar traffic shift also or alternatively to the third sector 1725B of the third site 1810-3 following the same operations. The computing system 150 can then determine, based on the particular percentage shifted to each neighboring sector, the updated values of the plurality of capacity metrics associated with the first sector 1725A, the second sector 1725B, and individual cells of the first sector 1725A and the second sector 1725B.

With additional reference to FIG. 17, in some embodiments, the component is a cell of the first site 1810-1 of the plurality of sites and the particular design change is associated with at least one of an antenna type, electronic tilt, mechanical tilt, azimuth, or height of an antenna of the cell. For example, these physical changes to cell or sector-related components can impact a gain, and thus RF radius capable of picking of traffic, of each site. In other embodiments, the component is a cell of a site of the plurality of sites and the particular design change is a change to a minimum power level needed to connect to the cell, an idle or active mobility threshold, or a carrier aggregation tuning with downlink cells.

In some embodiments, the component is a sector of the first site 1810-1 of the plurality of sites, the particular design change is adding a new cell to the sector (e.g., the first sector 1225A) or a new sector to the first site 1725A. The new cell would be added to the sector while the new sector is likely a fourth sector for the first site 1725A, causing all azimuths for all sectors to be recalibrated to add in the fourth sector, e.g., meaning each sector can be 90 degrees apart for maximum separation. Once the new sector is added, the new capacity metric can be calculated for the new sector and be added back in the database or central data sheet. IN this way, the other two adjacent sectors (to the new sector) can have a proportional capacity gain increase, e.g., of 20% or the like.

In at least some embodiments, the new cell or the new sector also includes a new frequency band for the first site 1810-1, e.g., which can be selected from the spectrum summary 808 (or associated dropdown menu) illustrated in FIG. 8. As discussed, adding a frequency band is a good way to add network capacity to the same sector. In some embodiments, the available spectrum depends or changes based on the current AOI. In some embodiments, the component is a site of the plurality of sites and the particular design change includes relocating the site to a new geographical location, where the new location may or may not be in the same AOI.

In some embodiments, the component is a first DU and the particular design change is balancing traffic between the first DU and a second DU of the AOI, implementing a software release within at least the first DU, and/or implementing a software feature within the first DU that increases a capacity threshold of the first DU. In other embodiments, the component is a DU associated with a first site and the particular design change includes adding an additional DU server, swapping or upgrading an existing DU server to a higher-capacity DU server, and/or rehoming sites, of the plurality of sites, between DUs that include the DU. Upgrading hardware and/or software of DUs can improve capacity of the sites that connect to the CU through those DUs. Rehoming can refer to shifting a fronthaul and/or mid-haul segment of a site to go through a different DU, e.g., when there is a dark site connected to a server and there is the possibility to connect such over-capacity site to another dark site server. In some embodiments, the component is a CU and the particular design change includes one of rehoming DUs between CUs, adding a CU user plane (UP) or CU-UP resource, or adding a CU control plane (CP) or CU-CP resource.

In some embodiments, the component is a front-haul (FH) segment or a mid-haul (MH) segment and the particular design change includes performing a soft upgrade (e.g., related to software) or a physical upgrade of one of the FH segment or the MH segment, respectively.

FIG. 19 is an image of a graphical object representing a site and illustrating optional addition of a new source of capacity to the sector according to some embodiments. With additional reference to FIG. 17, in some embodiments, the component is a site of the plurality of sites and the particular design change includes adding a new resource associated with the site. In at least one embodiment, the new resource is associated with a particular sector of the site, e.g., the first sector 1725A as illustrated, and a dashed sector indicator 1925 on the map can illustrate a general coverage by the new resource. The new resource can be, for example, a cell on wheels 1903, a new adjacent site 1910, an in-build site, or an adjacent small cell 1905 (or femtocell) that is smaller than cells of the site.

In embodiments, the radius of the dashed sector indicator 1925 is directed at the same azimuth as the first sector 1725A. For an additional site, in-build plan, a new site should already exist on the map (e.g., because its construction has already been planned). However, an operator may need to click or otherwise select the site of the in-build plan to store the site in a solution list for resolving congestion or other capacity issues that the dropdown solutions menu 1713 and the design change sub-menu 1715 are intended to solve.

In some embodiments, when adding a new build site, a new label will appear on the map within the dashed sector indicator 1925 and be available to export the solution. For example, the export can include the type of the new build and its location in longitude and latitude coordinates, which may be specified by the operator through an input text box or the like.

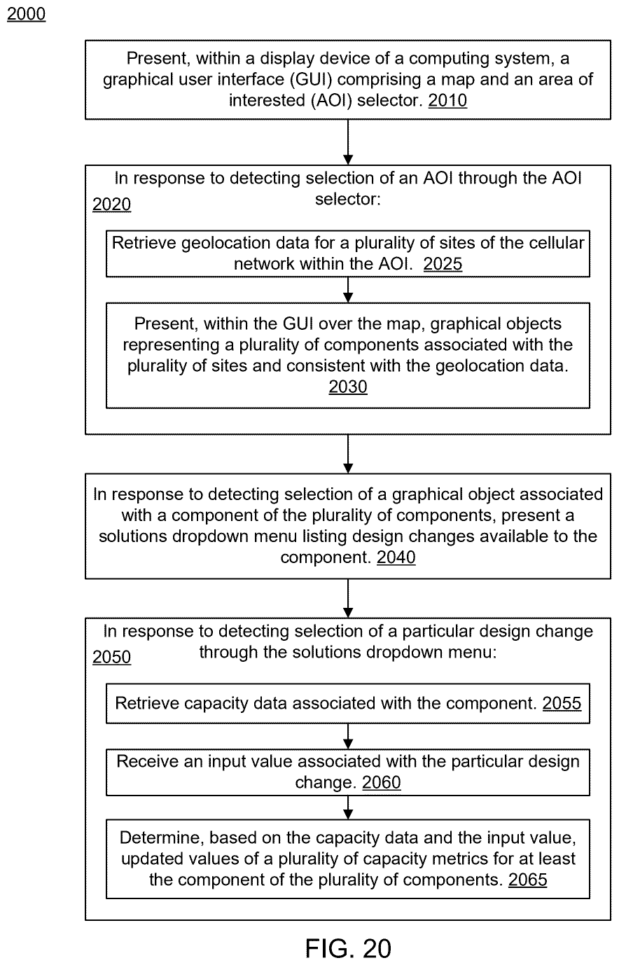

FIG. 20 is a flow chart of a method of offering solutions, through the GUI, via particular design changes to a component of a site according to some embodiments. The method 1600 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 1600 is performed by the computing system 150 of FIGS. 1A-1B with the GUI of the foregoing Figures. The method 1600 can also be performed by other computing systems described herein, such as in FIG. 21.

At operation 2010, present a graphical user interface (GUI), e.g., in a display device, including a map and an area of interest (AOI) selector.

At operation 2020, in response to detecting selection of an AOI through the AOI selector, the processing device, at operation 2025, retrieves geolocation data for a plurality of sites of the cellular network within the AOI and, at operation 2030, presents, within the GUI over the map, graphical objects representing a plurality of components associated with the plurality of sites and consistent with the geolocation data.

At operation 2040, in response to detecting selection of a graphical object associated with a component of the plurality of components, the processing logic presents a solutions dropdown menu listing design changes available to the component.

At operation 2050, in response to detecting selection of a particular design change through the solutions dropdown menu, the processing logic performs at least operations 2055 through 2065. For example, at operation 2055, the processing logic retrieves capacity data associated with the component. At operation 2060, the processing logic receives an input value associated with the particular design change. At operation 2065, the processing logic determines, based on the capacity data and the input value, updated values of a plurality of capacity metrics for at least the component of the plurality of components.

In some embodiments, the method 2000 can be extended to determining the plurality of capacity metrics for at least some of the plurality of components that are impacted by the input value and presenting, within the GUI, the updated values and the plurality of capacity metrics associated with the at least some of the plurality of components.

FIG. 21 illustrates a block diagram illustrating an exemplary computer device 2100 (or computing device), in accordance with implementations of the present disclosure. Computer device 2100 can correspond to the computing system 150 (or device), as described above. Example computer device 2100 can be connected to other computer devices in a LAN, an intranet, an extranet, and/or the Internet. Computer device 2100 can operate in the capacity of a server in a client-server network environment. Computer device 2100 can be a personal computer (PC), a set-top box (STB), a server, a network router, switch or bridge, or any device capable of executing a set of instructions (sequential or otherwise) that specify actions to be taken by that device. Further, while only a single example computer device is illustrated, the term “computer” shall also be taken to include any collection of computers that individually or jointly execute a set (or multiple sets) of instructions to perform any one or more of the methods discussed herein.

Example computer device 2100 can include a processing device 2102 (also referred to as a processor, CPU, or GPU), a volatile memory 2104 (or main memory, e.g., read-only memory (ROM), flash memory, dynamic random access memory (DRAM) such as synchronous DRAM (SDRAM), etc.), a non-volatile memory 2106 (e.g., flash memory, static random access memory (SRAM), etc.), and a secondary memory (e.g., a data storage device 2116), which can communicate with each other via a bus 2130.

Processing device 2102 (which can include processing logic 2122) represents one or more general-purpose processing devices such as a microprocessor, central processing unit, or the like. More particularly, processing device 2102 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 2102 can also be one or more special-purpose processing devices such as an ASIC, a FPGA, a digital signal processor (DSP), network processor, or the like. In accordance with one or more aspects of the present disclosure, processing device 2102 can be configured to execute instructions performing the method disclosed herein.

Example computer device 2100 can further comprise a network interface device 2108, which can be communicatively coupled to a network 2120. Example computer device 2100 can further comprise a video display 2110 (e.g., a LCD (liquid crystal display) or organic light-emitting diode (OLED) monitor, a virtual-reality (VR) or augmented-reality (AR) display, a touch screen, or a cathode ray tube (CRT)), an alphanumeric input device 2112 (e.g., a keyboard), a cursor control device 2114 (e.g., a mouse, track ball, or touch pad), and an acoustic signal generation device 2118 (e.g., a speaker). Other kinds of devices can be used to provide for interaction with a user as well; for example, feedback and responses provided to the user can be any form of sensory feedback, e.g., visual, auditory, speech or tactile; and input from the user can be received in any form, including acoustic, speech, or tactile input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

Data storage device 2116 can include a computer-readable storage medium 2124 (or, more specifically, a non-transitory computer-readable storage medium) on which is stored one or more sets of executable instructions 2126 (e.g., processor-readable instructions). In accordance with one or more aspects of the present disclosure, executable instructions 2126 can comprise executable instructions performing the method disclosed herein.

Executable instructions 2126 can also reside, completely or at least partially, within volatile memory 2104 and/or within processing device 2102 during execution thereof by example computer device 2100, volatile memory 2104 and processing device 2102 also constituting computer-readable storage media. Executable instructions 2126 can further be transmitted or received over a network via network interface device 2108.

While the computer-readable storage medium 2124 is shown in FIG. 21 as a single medium, the term “computer-readable storage medium” or “non-transitory computer-readable storage medium storing instructions” or “computer-readable instructions” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general-purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general-purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

Other variations are within the scope of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, the terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to actions and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. As non-limiting examples, a “processor” may be a network device or a MACsec device. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, the terms “system” and “method” are used herein interchangeably insofar as the system may embody one or more methods, and methods may be considered a system.

In the present document, references may be made to obtaining, acquiring, receiving, or inputting analog or digital data into a sub-system, computer system, or computer-implemented machine. In at least one embodiment, the process of obtaining, acquiring, receiving, or inputting analog and digital data can be accomplished in a variety of ways, such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface, or an inter-process communication mechanism.

Although descriptions herein set forth example embodiments of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that the subject matter claimed in appended claims is not necessarily limited to specific features or acts described.

Rather, specific features and acts are disclosed as exemplary forms of implementing the claims.

What is claimed is:

1. A computing system to facilitate a cellular network, the computing system comprising:
one or more processing devices; and
memory communicatively coupled with and readable by the one or more processing devices and having stored therein processor-readable instructions which, when executed by the one or more processing devices, cause the one or more processing devices to perform operations comprising:
presenting a graphical user interface (GUI) comprising a map and an input selector window comprising a plurality of component types of the cellular network associated with a plurality of sites; and
in response to detecting, through the input selector window, selection of one or more component types of the plurality of component types:
retrieving geolocation data for a plurality of components corresponding to the one or more component types;
presenting, within the GUI over the map, graphical objects representing the plurality of components consistent with the geolocation data;
retrieving capacity data associated with the plurality of components; and
shading, based on the capacity data, each graphical object to indicate a capacity status associated with each corresponding component of the plurality of components.

2. The computing system of claim 1, wherein the plurality of sites comprise active sites and in-construction sites, and wherein the one or more component types comprise at least one of cells or sectors of cells.

3. The computing system of claim 1, wherein
the plurality of component types comprise at least cells, centralized units (CUs), distributed units (DUs), front-haul segments, and mid-haul segments; and
when the one or more component types are selected, presenting the graphical objects within the GUI comprises presenting a subset of cells for each site, a plurality of DUs, at least one CU, a plurality of front-haul segments connecting each site to a respective DU, and a plurality of mid-haul segments connecting each DU to the at least one CU.

4. The computing system of claim 1, wherein the operations further comprise:
presenting an area of interest (AOI) selector; and
in response to detecting selection of an AOI, through the AOI selector, the retrieving the geolocation data and the capacity data is from a database portion that is specific to the AOI.

5. The computing system of claim 1, wherein, in response to detecting selection of a graphical object of the graphical objects, the operations further comprise:
determining, using the capacity data, a plurality of capacity metrics associated with the graphical object; and
presenting, within the GUI as an overlay of the map, a text box comprising values for the plurality of capacity metrics.

6. The computing system of claim 5, wherein:
the graphical object corresponds to one of a cell or a sector;
the plurality of capacity metrics comprise at least two of cell uplink throughput, cell downlink throughput, total physical resource block usage, a maximum number of radio resource control connections, or a user equipment throughput for cell downlinks.

7. The computing system of claim 5, wherein the operations further comprise presenting, in the text box, a plurality of element configurations and corresponding values comprising at least two of a frequency band name, a mechanical tilt, a vendor, an upload bandwidth, a download bandwidth, an azimuth, an electrical tilt, and a height.

8. The computing system of claim 5, wherein the graphical object corresponds to one of a front-haul segment or a mid-haul segment and the plurality of capacity metrics comprises at least two of interface transmission throughput, interface transmission link utilization, interface reception throughput, or interface reception link utilization.

9. The computing system of claim 5, wherein the graphical object corresponds to a DU and the plurality of capacity metrics comprise cell throughput for uplinks, total physical resource block (PRB) usage percent in downlinks, a maximum number of radio resource control (RRC) connections, cell throughput for downlinks, and total PRB usage percent in uplinks.

10. The computing system of claim 5, wherein the graphical object corresponds to a CU and the plurality of capacity metrics comprise a DU count threshold number, a cell count threshold number, a maximum number of radio resource control (RRC) connections, and a cell throughput for downlinks.

11. The computing system of claim 1, wherein the capacity status is one of on-air, satisfies a predetermined capacity threshold, or is within a particular percentage of the predetermined capacity threshold, and wherein the operations further comprise:
presenting, within the GUI, a date selector; and
in response to receiving an input selection of the date selector to a future date:
analyzing the capacity data to predict a plurality of capacity metrics at the future date for the plurality of components; and
changing shading of at least one graphical object, corresponding to a component of the plurality of components, indicating that at least one capacity metric of the plurality of capacity metrics for the component has a changed capacity status.

12. A method to facilitate a cellular network, the method comprising:
presenting, within a display device of a computing system, a graphical user interface (GUI) comprising a map and an input selector window comprising a plurality of component types of the cellular network associated with a plurality of sites; and
in response to detecting, through the input selector window, selection of one or more component types of the plurality of component types:
retrieving geolocation data for a plurality of components corresponding to the one or more component types;
presenting, within the GUI over the map, graphical objects representing the plurality of components consistent with the geolocation data;
retrieving, from memory, capacity data associated with the plurality of components; and
shading, based on the capacity data, each graphical object to indicate a capacity status associated with each corresponding component of the plurality of components.

13. The method of claim 12, wherein
the plurality of component types comprise at least cells, centralized units (CUs), distributed units (DUs), front-haul segments, and mid-haul segments; and
when the one or more component types are selected, presenting the graphical objects within the GUI comprises presenting a subset of cells for each site, a plurality of DUs, at least one CU, a plurality of front-haul segments connecting each site to a respective DU, and a plurality of mid-haul segments connecting each DU to the at least one CU.

14. The method of claim 12, further comprising:
presenting an area of interest (AOI) selector; and
in response to detecting selection of an AOI, through the AOI selector, the retrieving the geolocation data and the capacity data is from a database portion that is specific to the AOI.

15. The method of claim 12, wherein, in response to detecting selection of a graphical object of the graphical objects, the method further comprises:
determining, using the capacity data, a plurality of capacity metrics associated with the graphical object; and
presenting, within the GUI as an overlay of the map, a text box comprising values for the plurality of capacity metrics.

16. The method of claim 15, wherein:
the graphical object corresponds to one of a cell or a sector; and
the plurality of capacity metrics comprise at least two of cell uplink throughput, cell downlink throughput, total physical resource block (PRB) usage, a maximum number of radio resource control (RRC) connections, or a user equipment (UE) throughput for cell downlinks.

17. The method of claim 15, further comprises presenting, in the text box, a plurality of element configurations and corresponding values comprising at least two of a frequency band name, a mechanical tilt, a vendor, an upload bandwidth, a download bandwidth, an azimuth, an electrical tilt, and a height.

18. The method of claim 15, wherein the graphical object corresponds to one of a front-haul segment or a mid-haul segment and the plurality of capacity metrics comprises at least two of interface transmission throughput, interface transmission link utilization, interface reception throughput, or interface reception link utilization.

19. The method of claim 15, wherein the graphical object corresponds to a DU and the plurality of capacity metrics comprise cell throughput for uplinks, total physical resource block (PRB) usage percent in downlinks, a maximum number of radio resource control (RRC) connections, cell throughput for downlinks, and total PRB usage percent in uplinks.

20. The method of claim 15, wherein the graphical object corresponds to a CU and the plurality of capacity metrics comprise a DU count threshold number, a cell count threshold number, a maximum number of radio resource control (RRC) connections, and a cell throughput for downlinks.

21. The method of claim 12, wherein the capacity status is one of on-air, satisfies a predetermined capacity threshold, or is within a particular percentage of the predetermined capacity threshold, and wherein the method further comprises:
presenting, within the GUI, a date selector; and
in response to receiving an input selection of the date selector to a future date:
analyzing the capacity data to predict a plurality of capacity metrics at the future date for the plurality of components; and
changing shading of at least one graphical object, corresponding to a component of the plurality of components, indicating that at least one capacity metric of the plurality of capacity metrics for the component has a changed capacity status.

22. A non-transitory computer-readable storage medium, the computer-readable storage medium including instructions that when executed by a computing system, cause the computing system to perform operations comprising:
presenting, within a display device, a graphical user interface (GUI) comprising a map and an input selector window comprising a plurality of component types of a cellular network associated with a plurality of sites; and
in response to detecting, through the input selector window, selection of one or more component types of the plurality of component types:
retrieving geolocation data for a plurality of components corresponding to the one or more component types;
presenting, within the GUI over the map, graphical objects representing the plurality of components consistent with the geolocation data;
retrieving, from memory, capacity data associated with the plurality of components; and
shading, based on the capacity data, each graphical object to indicate a capacity status associated with each corresponding component of the plurality of components.
